(19) United States
(12) Patent Application Publication
(10) Pub. No.: US 2007/0208144 A1
(43) Pub. Date: Sep. 6, 2007

(54) POLY(ARYLENE ETHER) BLOCK COPOLYMER COMPOSITIONS, METHODS, AND ARTICLES

(75) Inventors: Erik R. Delsman, Breda (NL); Amy R. Freshour, Putte (NL); Farah Jean-Jacques Toublan, Albany, NY (US); Gary W. Yeager, Rexford, NY (US)

Correspondence Address: CANTOR COLBURN LLP - GE PLASTICS-NORYL, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/424,358

(22) Filed: Jun. 15, 2006

Related U.S. Application Data
(60) Provisional application No. 60/778,540, filed on Mar. 2, 2006.

(51) Int. Cl. C08G 65/331; C08L 71/12; C08G 77/42

(52) U.S. Cl. 525/394; 525/393; 528/25; 528/29

(57) ABSTRACT

Poly(arylene ether)-polysiloxane block copolymers and methods for their preparation are provided. The block copolymers include structural units derived from a poly(arylene ether), a hydroxyaryl-terminated polysiloxane, and an activated aromatic carbonate.

### CROSS REFERENCE TO RELATED APPLICATIONS

This application claims priority to U.S. Provisional Application Ser. No. 60/778,540, filed Mar. 2, 2006.

### BACKGROUND

The invention generally relates to a block copolymer that comprises at least one poly(arylene ether) block and at least one other polymer block. Further, the invention relates to methods for producing these poly(arylene ether) block copolymers.

Copolymers have been used in countless modern technical applications ranging from aeronautical and automotive applications to the production of medical devices. Many of the applications in which copolymers serve, involve mechanical, thermal and environmental stresses which require that the copolymer exhibit a high degree of mechanical, thermal, and chemical stability. Applications continue to be developed in for which known copolymers are unsuitable due to one or more deficiencies linked to mechanical, thermal, or chemical instability.

Despite the vast number of copolymeric materials that are known, there remains a need for new copolymer compositions having improved mechanical, thermal, and chemical stability characteristics. There also remains a need for economical block copolymer capable of compatibilizing blends of polymers with limited or negligible miscibility.

### SUMMARY

A general preparative route to a block copolymer comprising at least one poly(arylene ether) block is described. One embodiment is a method of preparing a poly(arylene ether)-polysiloxane block copolymer, comprising: reacting a poly(arylene ether) comprising a hydroxy group, a hydroxyaryl-terminated polysiloxane, and an activated aromatic carbonate.

Another embodiment is a method of preparing a poly(arylene ether)-poly(alkylene ether) block copolymer, comprising melt reacting a poly(arylene ether) comprising a hydroxy group, a hydroxyaryl-terminated polysiloxane, and bis(methyl salicyl) carbonate; wherein the poly(arylene ether) has an intrinsic viscosity of about 0.04 to about 0.2 deciliters per gram at 25° C. in chloroform and comprises 2,6-dimethyl-1,4-phenylene ether units, 2,3,6-trimethyl-1,4-phenylene ether units, or a combination thereof; wherein the hydroxyaryl-terminated polysiloxane has the structure

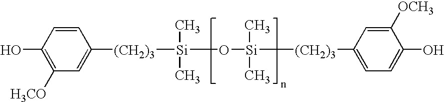

wherein n is about 10 to about 100; wherein the weight ratio of the poly(arylene ether) to the hydroxyaryl-terminated polysiloxane is about 1:3 to about 6:1; and wherein the activated aromatic carbonate is used in an amount of about 0.5 to about 2 moles per two moles of total hydroxy groups contributed by the poly(arylene ether) and the hydroxy-terminated polysiloxane.

Another embodiment is poly(arylene ether)-polysiloxane block copolymer, comprising: a poly(arylene ether) block; a hydroxyaryl-terminated polysiloxane block; and a carbonate group linking the poly(arylene ether) block and the polysiloxane block.

Another embodiment is a poly(arylene ether)-polysiloxane block copolymer, consisting of: at least one poly(arylene ether) block; at least one hydroxyaryl-terminated polysiloxane block; and at least one carbonate group linking the poly(arylene ether) block and the polysiloxane block.

Another embodiment is a poly(arylene ether)-polysiloxane block copolymer, comprising: a poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; a hydroxyaryl-terminated polysiloxane block having a number average molecular weight of about 1,000 to about 5,000 atomic mass units, wherein the hydroxyaryl-terminated polysiloxane block has the structure

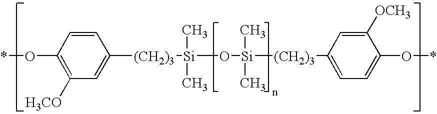

wherein n is about 5 to about 200; and a carbonate group linking the poly(arylene ether) block and the poly(alkylene ether) block.

Another embodiment is a poly(arylene ether)-polysiloxane block copolymer, consisting of: at least one poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; at least one hydroxyaryl-terminated polysiloxane block having a number average molecular weight of about 1,000 to about 8,000 atomic mass units, wherein the hydroxyaryl-terminated polysiloxane block has the structure

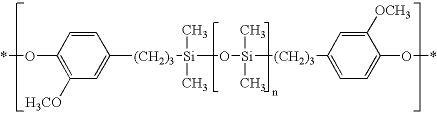

wherein n is about 5 to about 200; at least one carbonate group linking the poly(arylene ether) block and the poly(alkylene ether) block; and optionally, at least one endcap derived from an endcapping agent.

Other embodiments, including poly(arylene ether)-polysiloxane block copolymers prepared by the above methods and articles comprising poly(arylene ether)-polysiloxane block copolymers, are described in detail below.

### DETAILED DESCRIPTION

The present invention may be understood more readily by reference to the following detailed description of preferred embodiments and the examples included therein. In the following specification and the claims that follow, reference will be made to a number of terms that shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

The terms “first,” “second,” and the like herein do not denote any order, quantity, or importance, but rather are used to distinguish one element from another.

The modifier “about” used in connection with a quantity is inclusive of the stated value and has the meaning dictated by the context (for example, it includes the degree of error associated with measurement of the particular quantity).

As used herein, the term “melt crystalline” refers to block copolymers that exhibit, by differential scanning calorimetry, a melting transition on heating.

As used herein, the term “hydroxy group” as applied to the poly(arylene ether) is taken to include “aliphatic hydroxy groups” and “aromatic hydroxy groups” (or “phenolic hydroxy groups”). The term “aliphatic hydroxy group” as used herein refers to a hydroxy group attached to a non-aromatic carbon atom. Methanol, ethanol, ethylene glycol, cyclohexanol, sucrose, dextrose, benzyl alcohol, and cholesterol are illustrative examples of compounds comprising aliphatic hydroxy groups. The term “aromatic hydroxy group” refers to a hydroxy group attached to an aromatic carbon atom. Phenol, hydroquinone, beta-naphthol, 1,3,5-trihydroxybenzene, and 3-hydroxypyridine exemplify compounds comprising one or more aromatic hydroxy groups. A “terminal hydroxy group” is a hydroxy group at the end of a polymer or oligomer chain.

As used herein the term “aliphatic radical” refers to an organic radical having a valence of at least one comprising a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example, fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl; difluorovinylidene; trichloromethyl, bromodichloromethyl, bromoethyl, 2-bromotrimethylene (—CH₂CHBrCH₂—), and the like. Further examples of aliphatic radicals include allyl, aminocarbonyl (—CONH₂), carbonyl, dicyanoisopropylidene (—CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethyoxysilypropyl ((CH₃O)₃SiCH₂CH₂CH₂—), vinyl, vinylidene, and the like. By way of further example, a C₁-C₁₀ aliphatic radical contains at least one but no more than 10 carbon atoms. A methyl group (CH₃—) is an example of a C₁ aliphatic radical. A decyl group (CH₃(CH₂)₁₀—) is an example of a C₁₀ aliphatic radical.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical may also include nonaromatic components. For example, a benzyl group is an aromatic radical that comprises a phenyl ring (the aromatic group) and a methylene group (the nonaromatic component). Similarly a tetrahydronaphthyl radical is an aromatic radical comprising an aromatic group (C₆H₃) fused to a nonaromatic component, —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehydes groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as trifluoromethylphenyl, hexafluoroisopropylidenebis(4-phen-1-yloxy) (—OPhC(CF₃)₂PhO—), chloromethylphenyl; 3-trifluorovinyl-2-thienyl; 3-trichloromethylphen-1-yl (3-CCl₃Ph-), 4(3-bromoprop-1-yl)phen-1-yl (BrCH₂CH₂CH₂Ph-), and the like. Further examples of aromatic radicals include 4-allyloxyphen-1-oxy, 4-aminophen-1-yl (H₂NPh-), 3-aminocarbonylphen-1-yl (NH₂COPh-), 4-benzoylphen-1-yl, dicyanoisopropylidenebis(4-phen-1-yloxy) (—OPhC(CN)₂PhO—), 3-methylphen-1-yl, methylenebis(phen-4-yloxy) (—OPhCH₂PhO—), 2-ethylphen-1-yl, phenylethenyl, 3-formyl-2-thienyl, 2-hexyl-5-furanyl; hexamethylene-1,6-bis(phen-4-yloxy) (—OPh(CH₂)₆PhO—); 4-hydroxymethylphen-1-yl (4-HOCH₂Ph-), 4-mercaptomethylphen-1-yl (4-HSCH₂Ph-), 4-methylthiophen-1-yl (4-CH₃SPh-), 3-methoxyphen-1-yl, 2-methoxycarbonylphen-1-yloxy (methyl salicyl), 2-nitromethylphen-1-yl (—PhCH₂NO₂), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical that comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example, fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene2,2-bis (cyclohex-4-yl) (—C₆H₁₀C(CF₃)₂C₆H₁₀—), 2-chloromethylcyclohex-1-yl; 3-difluoromethylenecyclohex-1-yl; 4-trichloromethylcyclohex-1-yloxy, 4-bromodichloromethylcyclohex-1-ylthio, 2-bromoethylcyclopent-1-yl, 2-bromopropylcyclohex-1-yloxy (CH₃CHBrCH₂C₆H₁₀—), and the like. Further examples of cycloaliphatic radicals include 4-allyloxycyclohex-1-yl, 4-aminocyclohex-1-yl (H₂NC₆H₁₀—), 4-aminocarbonylcyclopent-1-yl (NH₂COC₅H₈—), 4-acetyloxycyclohex-1-yl, 2,2-dicyanoisopropylidenebis(cyclohex-4-yloxy) (—OC₆H₁₀C(CN)₂C₆H₁₀O—), 3-methylcyclohex-1-yl, methylenebis(cyclohex-4-yloxy) (—OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl; hexamethylene-1,6-bis(cyclohex-4-yloxy) (—OC₆H₁₀(CH₂)₆C₆H₁₀O—); 4-hydroxymethylcyclohex-1-yl (4-HOCH₂C₆H₁₀—), 4-mercaptomethylcyclohex-1-yl (4-HSCH₂C₆H₁₀—), 4-methylthiocyclohex-1-yl (4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (NO₂CH₂C₆H₁₀—), 3-trimethylsilylcyclohex-1-yl, 2-t-butyldimethylsilylcyclopent-1-yl, 4-trimethoxysilylethylcyclohex-1-yl ((CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. The hydrocarbyl residue, when so stated however, may contain heteroatoms over and above the carbon and hydrogen members of the substituent residue. Thus, when specifically noted as containing such heteroatoms, the hydrocarbyl or hydrocarbylene residue may also contain carbonyl groups, amino groups, hydroxy groups, or the like, or it may contain heteroatoms within the backbone of the hydrocarbyl residue.

As used herein, when describing an oligomeric polycarbonate, the expression “polycarbonate repeat units derived from a dihydroxy aromatic compound” means a repeat unit incorporated into an oligomeric polycarbonate by reaction of a dihydroxy aromatic compound with a source of carbonyl units, for example the reaction of bisphenol A with bis(methyl salicyl) carbonate.

As used herein, the term “solvent” can refer to a single solvent or a mixture of solvents.

As used herein, the term “melt polycarbonate” refers to a polycarbonate comprising structural units made by the transesterification of a diaryl carbonate with a dihydroxy aromatic compound.

“BPA” is herein defined as bisphenol A or 2,2-bis(4-hydroxyphenyl)propane.

As used herein, the terms “diaryl carbonate” and “ester substituted diaryl carbonate” are used interchangeably with the terms “aromatic carbonate” and “ester substituted aromatic carbonate” respectively.

The terms “double-screw extruder” and “twin-screw extruder” are used interchangeably herein.

The terms “formula” and “structure” are used interchangeably herein.

As used herein, the term “monofunctional phenol” means a phenol comprising a single aromatic hydroxy group.

The terms “vent port” and “vent” are used interchangeably herein.

The term “atmospheric vent” as used herein is meant to indicate a vent that is operated at or near atmospheric pressure. Thus, an atmospheric vent being operated under a slight vacuum, such as that commonly designated “house vacuum”, is meant to fall within the ambit of the term “atmospheric vent”.

As noted above, the invention generally relates to block copolymers comprising poly(arylene ether) blocks, to methods of making such block copolymers, and to articles comprising such copolymers. In general, the block copolymers are prepared by reaction of a poly(arylene ether), a different (not poly(arylene ether)) polymer having at least one reactive hydroxy group, and a carbonate precursor capable of forming a link between the poly(arylene ether) and the different polymer. Given the low reactivity of ortho-disubstituted phenols with diaryl carbonates, and given questions about the solubility of poly(arylene ether)s in low concentrations of diaryl carbonates and the corresponding aryl alcohols, it was unexpected that diaryl carbonate could be used to efficiently form poly(arylene ether)-containing block copolymers, particularly in a melt reaction.

In one embodiment, the other polymer is a polycarbonate, and the resulting block copolymer is a poly(arylene ether)-polycarbonate block copolymer. In another embodiment, the other polymer is a poly(alkylene ether), and the resulting block copolymer is a poly(arylene ether)-poly(alkylene ether) block copolymer. In another embodiment, the other polymer is a hydroxyaryl-terminated polysiloxane, and the resulting block copolymer is a poly(arylene ether)-polysiloxane block copolymer. In another embodiment, the other polymer is a hydroxy-terminated polyester, and the resulting block copolymer is a poly(arylene ether)-polyester block copolymer.

Poly(Arylene Ether)-Polycarbonate Block Copolymers

One embodiment is a poly(arylene ether)-polycarbonate block copolymer comprising structural units derived from: (A) a hydroquinone; (B) a poly(arylene ether) comprising a hydroxy group; (C) optionally, a dihydroxy aromatic compound other than the hydroquinone; and (D) an activated aromatic carbonate.

In some embodiments, the poly(arylene ether)-polycarbonate block copolymer is melt crystalline. In general, the poly(arylene ether)-polycarbonate block copolymer is melt crystalline if differential scanning calorimetry of the copolymer reveals a melting transition on heating. In one embodiment, the melt crystalline property is manifested during the course of a melt polymerization used to form the crystalline block copolymers. In another embodiment, the melt crystalline behavior is believed to result from the presence of a morphological hierarchy, which may be present in the molten state, such as for example, spherulites; block copolymer micro-domains; lamellar crystals; and crystalline block unit cells. Thus for example, one or more of these morphological states may function as microphase-segregated domains and act as crystallization templates, thereby inducing fast crystallization of the block copolymer. Thus, in one embodiment, melt crystalline behavior is manifested when the poly(arylene ether)-polycarbonate block copolymer melt is at a temperature from just above the glass transition temperature to just below the melting temperature.

Reactant (A) is a hydroquinone. Suitable hydroquinones include those having the structure

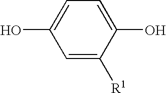

wherein R¹ represents a monovalent C₁-C₁₂ aliphatic radical, a C₃-C₁₀ cycloaliphatic radical, or a C₃-C₁₀ aromatic radical. In one embodiment, the hydroquinone monomer comprises at least one of 1,4-hydroquinone and 2-methyl-1,4-hydroquinone.

Reactant (B) is a poly(arylene ether) comprising a hydroxy group. It will be understood that the poly(arylene ether) may comprise more than one hydroxy group. The term “poly(arylene ether)” includes any oligomer or polymer described as a “polyphenylene ether” in U.S. Provisional Application Ser. No. 60/778,540, filed Mar. 2, 2006. Suitable poly(arylene ether)s include those comprising repeating units having the structure

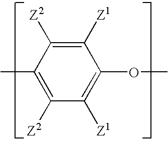

wherein for each repeating unit, each Z¹ is independently halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atom. In one embodiment, each Z¹ is methyl, and each Z² is independently hydrogen or methyl. In one embodiment, the poly(arylene ether) comprises 2,6-dimethyl-1,4-phenylene ether units, 2,3,6-trimethyl-1,4-phenylene ether units, or a combination thereof.

In one embodiment, the poly(arylene ether) has an intrinsic viscosity of about 0.04 to about 0.6 deciliter per gram at 25° C. in chloroform. Within this range, the poly(arylene ether) may have an intrinsic viscosity of at least about 0.06 deciliter per gram, or at least about 0.09 deciliter per gram, or at least about 0.12 deciliter per gram. Also within this range, the poly(arylene ether) may have an intrinsic viscosity of up to about 0.4 deciliter per gram, or up to about 0.3 deciliter per gram, or up to about 0.2 deciliter per gram. Those skilled in the art understand that the intrinsic viscosity of a poly(arylene ether) may increase by up to 30% under melt reaction and/or melt-kneading conditions. The above intrinsic viscosity range of 0.04 to about 0.6 deciliter per gram is intended to encompass intrinsic viscosities both before and after melt reaction and/or melt-kneading. Blends of two or more poly(arylene ether)s having different intrinsic viscosities may be used.

In one embodiment, about 50 to about 95 mole percent of a total molar amount of the poly(arylene ether) comprises a hydroxy group.

In one embodiment, the poly(arylene ether) has, on average, about 0.5 to 1 aromatic hydroxy group per chain. The aromatic hydroxy groups may be terminal or internal with respect to the poly(arylene ether) chain. Poly(arylene ether)s prepared by oxidative polymerization of a monohydric phenol or a mixture of monohydric phenols often have hydroxy group contents in this range. Blends of two or more poly(arylene ether)s having different average numbers of hydroxy groups per chain may be used.

In one embodiment, the poly(arylene ether) has, on average, greater than 1 aromatic hydroxy group per chain. Various methods of producing such poly(arylene ether)s, some of which are referred to as bifunctional poly(arylene ether)s, are known. For example, a poly(arylene ether) produced by oxidative polymerization of a monohydric phenol may be “redistributed” by reaction with an oxidizing agent and a dihydric or polyhydric phenol. As another example, a bifunctional poly(arylene ether) may be produced directly by oxidative polymerization of a mixture of a monohydric phenol, such as 2,6-xylenol, and a dihydric or polyhydric phenol, such as 4,4′-isopropylidene bis(2,6-dimethylphenol). Additional methods of producing poly(arylene ether)s having more than one phenolic hydroxy group per molecule are described in U.S. Patent Application Publication No. US 2006/0041086 A1 of Birsak et al. Methods of determining the number of aromatic hydroxy groups per chain are known in the art. For example, the number of aromatic hydroxy groups per chain may be calculated from the parts per million by weight of hydroxy groups and the number average molecular weight of the poly(arylene ether), where the parts per million by weight of hydroxy groups may be determined by Fourier transform infrared spectroscopy using aromatic phenol standards, and the number average molecular weight of the poly(arylene ether) may be determined by gel permeation chromatography using poly(arylene ether) standards.

In some embodiments, the poly(arylene ether) has, on average, greater than 2 hydroxy groups per chain, and such hydroxy groups may occur in the middle of a chain as well as at the ends of a chain.

Suitable poly(arylene ether)s disclosed in the art may also be used. Both homopolymer and copolymer poly(arylene ether)s are included. Suitable homopolymers are those containing, for example, 2,6-dimethyl-1,4-phenylene ether units. Suitable copolymers include random copolymers containing such units in combination with (for example) 2,3,6-trimethyl-1,4-phenylene ether units. Many suitable random copolymers, as well as homopolymers, are disclosed in the patent literature

Also included are poly(arylene ether)s containing moieties that modify properties such as molecular weight, melt viscosity and/or impact strength. Such polymers are described in the patent literature and may be prepared by grafting onto the poly(arylene ether) in known manner such vinyl monomers as acrylonitrile and vinylaromatic compounds (for example, styrene), or such polymers as polystyrenes and elastomers. The product typically contains both grafted and un-grafted moieties. Other suitable polymers are the coupled poly(arylene ether)s in which the coupling agent is reacted in known manner with the hydroxy groups of two poly(arylene ether) chains to produce a higher molecular weight polymer containing the reaction product of the hydroxy groups and the coupling agent, provided substantial proportions of hydroxy groups remain present. Illustrative coupling agents are low molecular weight polycarbonates, quinones, heterocycles and formals. In some embodiments, the poly(arylene ether) is not functionalized with reactive groups other than those resulting from the oxidative polymerization by which it is formed. For example, in one embodiment, the poly(arylene ether) has not been functionalized to contain epoxy groups, carboxylic acid groups, anhydride groups, polymerizable carbon-carbon double bonds (such as those present in acrylate groups), carbodiimide groups, or the like.

In some embodiments, the poly(arylene ether) can comprise aliphatic hydroxy groups, or combinations of aliphatic hydroxy groups and aromatic hydroxy groups. These poly(arylene ether)s can be prepared, for example, by reaction of hydroxy-terminated poly(arylene ether) with an omega-haloalkyl hydroxy compound, wherein the hydroxy group can be an aliphatic hydroxy group. The resulting product, a poly(arylene ether) terminated by omega-hydroxyalkyl groups can be used as a macro-monomer for preparing the poly(arylene ether)-polycarbonate block copolymers. In one embodiment, the poly(arylene ether) is a poly(arylene ether) comprising 2,6-dimethyl-1,4-phenylene ether groups. Such poly(arylene ether)s comprise aromatic hydroxy groups, and they are easily prepared by oxidative polymerization of 2,6-dimethylphenol or a mixture of phenols including 2,6-dimethylphenol.

Component (C) used in forming the PPE-PC block copolymer is optional and is a dihydroxy aromatic compound other than the hydroquinone. The dihydroxy aromatic compound of component (C) includes bisphenols having the structure

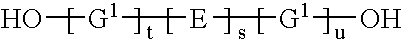

wherein each G¹ is independently at each occurrence a C₆-C₂₀ aromatic radical; E is independently at each occurrence a bond, a C₃-C₂₀ cycloaliphatic radical, a C₃-C₂₀ aromatic radical, a C₁-C₂₀ aliphatic radical, a nitrogen-containing linkage, a silicon-containing linkage, a sulfur-containing linkage, a selenium-containing linkage, a phosphorus-containing linkage, or an oxygen atom; “t” is a number greater than or equal to one; “s” is either zero or one; and “u” is a whole number including zero. In various embodiments, “t” can have values from 1 to 10, from 1 to 5, from 1 to 3, and preferably 1. Similarly, in various embodiments “u” can have values from 1 to 10, from 1 to 5, from 1 to 3, and preferably 1.

As defined herein, a “nitrogen-containing linkage” includes tertiary nitrogen-containing linkages. As defined herein, a “silicon-containing linkage” includes silane type linkages and siloxane type linkages. As defined herein, a “sulfur-containing linkage” includes a sulfide group, a sulfoxide group, and a sulfone group. As defined herein, a “selenium-containing linkage” includes a selenide group, a selenoxide group, and a selenone group. As defined herein, a “phosphorus-containing linkage” is defined to include trivalent, tetravalent, or pentavalent phosphorus, some non-limiting examples of which include the phosphonyl and phosphinyl type linkages. The phosphorus atom may be bonded through carbon-containing groups, oxygen-containing groups, sulfur-containing groups, or selenium-containing groups. In some embodiments, the phosphorus atom may be bonded to other inorganic groups, such as for example hydroxy groups or their metal salt derivatives, such as ONa, OK, OLi, and the like. The phosphorus atom may also be bonded through oxygen, sulfur, or selenium to organic groups, such as C₃-C₂₀ cycloaliphatic radicals, C₃-C₂₀ aromatic radicals, or C₁-C₂₀ aliphatic radicals.

Suitable examples of structural unit “E” include cyclopentylidene, cyclohexylidene, 3,3,5-trimethylcyclohexylidene, methylcyclohexylidene, [2.2.1]-bicycloheptylidene, neopentylidene, cyclopentadecylidene, cyclododecylidene, and adamantylidene. Suitable bisphenols are illustrated by 1,1-bis(4-hydroxyphenyl)cyclopentane; 2,2-bis(3-allyl-4-hydroxyphenyl)propane; 2,2-bis(2-t-butyl-4-hydroxy-5-methylphenyl)propane; 2,2-bis(3-t-butyl-4-hydroxy-6-methylphenyl)propane; 2,2-bis(3-t-butyl-4-hydroxy-6-methylphenyl)butane; 1,3-bis[4-hydroxyphenyl-1-(1-methylethylidine)]benzene; 1,4-bis[4-hydroxyphenyl-1-(1-methylethylidine)]benzene; 1,3-bis[3-t-butyl-4-hydroxy-6-methylphenyl-1-(1-methylethylidine)]benzene; 1,4-bis[3-t-butyl-4-hydroxy-6-methylphenyl-1-(1-methylethylidine)]benzene; 4,4′-biphenol; 3,3′,5,5′-tetrabromo-2,2′,6,6′-tetramethyl-4,4′-biphenol; 2,2′,6,6′-tetramethyl-3,3′,5-tribromo-4,4′-biphenol; 1,1-bis(4-hydroxyphenyl)-2,2,2-trichloroethane; 2,2-bis(4-hydroxyphenyl-1,1,1,3,3,3-hexafluoropropane); 1,1-bis(4-hydroxyphenyl)-1-cyanoethane; 1,1-bis(4-hydroxyphenyl)dicyanomethane; 1,1-bis(4-hydroxyphenyl)-1-cyano-1-phenylmethane; 2,2-bis(3-methyl-4-hydroxyphenyl)propane; 1,1-bis(4-hydroxyphenyl)norbornane; 9,9-bis(4-hydroxyphenyl)fluorene; 3,3-bis(4-hydroxyphenyl)phthalide; 1,2-bis(4-hydroxyphenyl)ethane; 1,3-bis(4-hydroxyphenyl)propenone; bis(4-hydroxyphenyl) sulfide; 4,4′-oxydiphenol; 4,4-bis(4-hydroxyphenyl)pentanoic acid; 4,4-bis(3,5-dimethyl-4-hydroxyphenyl)pentanoic acid; 2,2-bis(4-hydroxyphenyl) acetic acid; 2,4′-dihydroxydiphenylmethane; 2,2-bis(2-hydroxyphenyl)methane; bis(4-hydroxyphenyl)methane; bis(4-hydroxy-3-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (bisphenol-A); 1,1-bis(4-hydroxyphenyl)propane; 2,2-bis(3-chloro-4-hydroxyphenyl)propane; 2,2-bis(3-bromo-4-hydroxyphenyl)propane; 2,2-bis(4-hydroxy-3-methylphenyl)propane; 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 2,2-bis(3,5-dichloro-4-hydroxyphenyl)propane; 2,2-bis(3,5-dibromo-4-hydroxyphenyl)propane; 2,2-bis(3,5-dimethyl-4-hydroxyphenyl)propane; 2,2-bis(3-chloro-4-hydroxy-5-methylphenyl)propane; 2,2-bis(3-bromo-4-hydroxy-5-methylphenyl)propane; 2,2-bis(3-chloro-4-hydroxy-5-isopropylphenyl)propane; 2,2-bis(3-bromo-4-hydroxy-5-isopropylphenyl)propane; 2,2-bis(3-t-butyl-5-chloro-4-hydroxyphenyl)propane; 2,2-bis(3-bromo-5-t-butyl-4-hydroxyphenyl)propane; 2,2-bis(3-chloro-5-phenyl-4-hydroxyphenyl)propane; 2,2-bis(3-bromo-5-phenyl-4-hydroxyphenyl)propane; 2,2-bis(3,5-disopropyl-4-hydroxyphenyl)propane; 2,2-bis(3,5-di-t-butyl-4-hydroxyphenyl)propane; 2,2-bis(3,5-diphenyl-4-hydroxyphenyl)propane; 2,2-bis(4-hydroxy-2,3,5,6-tetrachlorophenyl)propane; 2,2-bis(4-hydroxy-2,3,5,6-tetrabromophenyl)propane; 2,2-bis(4-hydroxy-2,3,5,6-tetramethylphenyl)propane; 2,2-bis(2,6-dichloro-3,5-dimethyl-4-hydroxyphenyl)propane; 2,2-bis(2,6-dibromo-3,5-dimethyl-4-hydroxyphenyl)propane; 2,2-bis(4-hydroxy-3-ethylphenyl)propane; 2,2-bis(4-hydroxy-3,5-dimethylphenyl)propane; 2,2-bis(3,5,3′,5′-tetrachloro-4,4′-dihydroxyphenyl)propane; 1,1-bis(4-hydroxyphenyl)cyclohexylmethane; 2,2-bis(4-hydroxyphenyl)-1-phenylpropane; 1,1-bis(4-hydroxyphenyl)cyclohexane; 1,1-bis(3-chloro-4-hydroxyphenyl)cyclohexane; 1,1-bis(3-bromo-4-hydroxyphenyl)cyclohexane; 1,1-bis(4-hydroxy-3-methylphenyl)cyclohexane; 1,1-bis(4-hydroxy-3-isopropylphenyl)cyclohexane; 1,1-bis(3-t-butyl-4-hydroxyphenyl)cyclohexane; 1,1-bis(3-phenyl-4-hydroxyphenyl)cyclohexane; 1,1-bis(3,5-dichloro-4-hydroxyphenyl)cyclohexane; 1,1-bis(3,5-dibromo-4-hydroxyphenyl)cyclohexane; 1,1-bis(3,5-dimethyl-4-hydroxyphenyl)cyclohexane; 4,4′-[1-methyl-4-(1-methyl-ethyl)-1,3-cyclohexandiyl]bisphenol (1,3 BHPM); 4-[1-[3-(4-hydroxyphenyl)-4-methylcyclohexyl]-1-methyl-ethyl]-phenol (2,8 BHPM); 3,8-dihydroxy-5a, 10b-diphenylcoumarano-2′,3′,2,3-coumarane (DCBP); 2-phenyl-3,3-bis(4-hydroxyphenyl)phthalimidine; 1,1-bis(3-chloro-4-hydroxy-5-methylphenyl)cyclohexane; 1,1-bis(3-bromo-4-hydroxy-5-methylphenyl)cyclohexane; 1,1-bis(3-chloro-4-hydroxy-5-isopropylphenyl)cyclohexane; 1,1-bis(3-bromo-4-hydroxy-5-isopropylphenyl)cyclohexane; 1,1-bis(3-t-butyl-5-chloro-4-hydroxyphenyl)cyclohexane; 1,1-bis(3-bromo-5-t-butyl-4-hydroxyphenyl)cyclohexane; 1,1-bis(3-chloro-5-phenyl-4-hydroxyphenyl)cyclohexane; 1,1-bis(3-bromo-5-phenyl-4-hydroxyphenyl)cyclohexane; 1,1-bis(3,5-disopropyl-4-hydroxyphenyl)cyclohexane; 1,1-bis(3,5-di-t-butyl-4-hydroxyphenyl)cyclohexane; 1,1-bis(3,5-diphenyl-4-hydroxyphenyl)cyclohexane; 1,1-bis(4-hydroxy-2,3,5,6-tetrachlorophenyl)cyclohexane; 1,1-bis(4-hydroxy-2,3,5,6-tetrabromophenyl)cyclohexane; 1,1-bis(4-hydroxy-2,3,5,6-tetramethylphenyl)cyclohexane; 1,1-bis(2,6-dichloro-3,5-dimethyl-4-hydroxyphenyl)cyclohexane; 1,1-bis(2,6-dibromo-3,5-dimethyl-4-hydroxyphenyl)cyclohexane; 1,1-bis(4-hydroxyphenyl)-3,3,5-trimethylcyclohexane; 1,1-bis(3-chloro-4-hydroxyphenyl)-3,3,5-trimethylcyclohexane; 1,1-bis(3-bromo-4-hydroxyphenyl)-3,3,5-trimethylcyclohexane; 1,1-bis(4-hydroxy-3-methylphenyl)-3,3,5-trimethylcyclohexane; 1,1-bis(4-hydroxy-3-isopropylphenyl)-3,3,5-trimethylcyclohexane; 1-bis(3-t-butyl-4-hydroxyphenyl)-3,3,5-trimethylcyclohexane; 1,1-bis(3-phenyl-4-hydroxyphenyl)-3,3,5-trimethylcyclohexane; 1,1-bis(3,5-dichloro-4-hydroxyphenyl)-3,3,5-trimethylcyclohexane; 1,1-bis(3,5-dibromo-4-hydroxyphenyl)-3,3,5-trimethylcyclohexane; 1,1-bis(3,5-dimethyl-4-hydroxyphenyl)-3,3,5-trimethylcyclohexane; 1,1-bis(3-chloro-4-hydroxy-5-methylphenyl)-3,3,5-trimethylcyclohexane; 1,1-bis(3-bromo-4-hydroxy-5-methylphenyl)-3,3,5-trimethylcyclohexane; 1,1-bis(3-chloro-4-hydroxy-5-isopropylphenyl)-3,3,5-trimethylcyclohexane; 1,1-bis(3-bromo-4-hydroxy-5-isopropylphenyl)-3,3,5-trimethylcyclohexane; 1,1-bis(3-t-butyl-5-chloro-4-hydroxyphenyl)-3,3,5-trimethylcyclohexane; 1,1-bis(3-bromo-5-t-butyl-4-hydroxyphenyl)-3,3,5-trimethylcyclohexane; bis(3-chloro-5-phenyl-4-hydroxyphenyl)-3,3,5-trimethylcyclohexane; 1,1-bis(3-bromo-5-phenyl-4-hydroxyphenyl)-3,3,5-trimethylcyclohexane; 1,1-bis(3,5-disopropyl-4-hydroxyphenyl)-3,3,5-trimethylcyclohexane; 1,1-bis(3,5-di-t-butyl-4-hydroxyphenyl)-3,3,5-trimethylcyclohexane; 1,1-bis(3,5-diphenyl-4-hydroxyphenyl)-3,3,5-trimethylcyclohexane; 1,1-bis(4-hydroxy-2,3,5,6-tetrachlorophenyl)-3,3,5-trimethylcyclohexane; 1,1-bis(4-hydroxy-2,3,5,6-tetrabromophenyl)-3,3,5-trimethylcyclohexane; 1,1-bis(4-hydroxy-2,3,5,6-tetramethylphenyl)-3,3,5-trimethylcyclohexane; 1,1-bis(2,6-dichloro-3,5-dimethyl-4-hydroxyphenyl)-3,3,5-trimethylcyclohexane; 1,1-bis(2,6-dibromo-3,5-dimethyl-4-hydroxyphenyl)-3,3,5-trimethylcyclohexane; 4,4-bis(4-hydroxyphenyl)heptane; 1,1-bis(4-hydroxyphenyl)decane; 1,1-bis(4-hydroxyphenyl)cyclododecane; 1,1-bis(3,5-dimethyl-4-hydroxyphenyl)cyclododecane; 4,4′dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-(3,3,5-trimethylcyclohexylidene)diphenol; 4,4′-bis(3,5-dimethyl)diphenol; 4,4′-dihydroxydiphenylether; 4,4′-dihydroxydiphenylthioether; 1,3-bis(2-(4-hydroxyphenyl)-2-propyl)benzene; 1,3-bis(2-(4-hydroxy-3-methylphenyl)-2-propyl)benzene; 1,4-bis(2-(4-hydroxyphenyl)-2-propyl)benzene; 1,4-bis(2-(4-hydroxy-3-methylphenyl)-2-propyl)benzene; 2,4′-dihydroxyphenyl sulfone; 4,4′-dihydroxydiphenylsulfone (BPS); bis(4-hydroxyphenyl)methane; 2,6-dihydroxy naphthalene; resorcinol; C 3 alkyl-substituted resorcinols; 3-(4-hydroxyphenyl)-1,1,3-trimethylindan-5-ol; 1-(4-hydroxyphenyl)-1,3,3-trimethylindan-5-ol; 4,4-dihydroxydiphenyl ether; 4,4-dihydroxy-3,3-dichlorodiphenylether; 4,4-dihydroxy-2,5-dihydroxydiphenyl ether; 4,4-thiodiphenol; 2,2,2′,2′-tetrahydro-3,3,3′,3′-tetramethyl-1,1′-spirobi[1H-indene]-6,6′-diol; and mixtures thereof. In a preferred embodiment, bisphenol A is used as the dihydroxy aromatic compound to form the polycarbonate block.

As noted, the poly(arylene ether)-polycarbonate block copolymer compositions comprise structural units derived from an activated aromatic carbonate (Component (D)). As used herein, the term “activated aromatic carbonate” is defined as a diaryl carbonate that is more reactive than diphenyl carbonate in a model transesterification reaction with a monofunctional phenol. Such activated aromatic carbonates include those represented by the structure

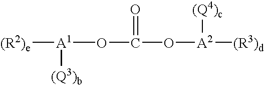

wherein A¹ and A² are each independently aromatic rings each having a number of positions available for substitution; R² and R³ are independently at each occurrence a halogen, a cyano group, a nitro group, a C₁-C₂₀ alkyl group, a C₄-C₂₀ cycloalkyl group, a C₄-C₂₀ aromatic group, a C₁-C₂₀ alkoxy group, a C₄-C₂₀ cycloalkoxy group, a C₄-C₂₀ aryloxy group, a C₁-C₂₀ alkylthio group, a C₄-C₂₀ cycloalkylthio group, a C₄-C₂₀ arylthio group, a C₁-C₂₀ alkylsulfinyl group, a C₄-C₂₀ cycloalkylsulfinyl group, a C₄-C₂₀ arylsulfinyl group, a C₁-C₂₀ alkylsulfonyl group, a C₄-C₂₀ cycloalkylsulfonyl group, a C₄-C₂₀ arylsulfonyl group, a C₁-C₂₀ alkoxycarbonyl group, a C₄-C₂₀ cycloalkoxycarbonyl group, a C₄-C₂₀ aryloxycarbonyl group, a C₂-C₆₀ alkylamino group, a C₆-C₆₀ cycloalkylamino group, a C₅-C₆₀ arylamino group, a C₁-C₄₀ alkylaminocarbonyl group, a C₄-C₄₀ cycloalkylaminocarbonyl group, a C₄-C₄₀ arylaminocarbonyl group, and a C₁-C₂₀ acylamino group; “d” and “e” are independently integers from and including 0 to the number of positions available for substitution on A¹ and A² respectively; Q³ and Q⁴ are each independently activating groups selected from the group consisting of an alkoxycarbonyl group, a formyl group, a halogen atom, a nitro group, an amide group, a sulfone group, a sulfoxide group, and an imine group, an amidine group, and aminocarbonyl and amidine moieties having structures

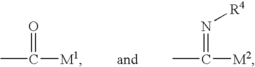

wherein M¹ and M² are independently N-alkyl, N,N-dialkyl, N-aryl, N,N-diaryl, or N-alkylaryl, N,N-dialkylaryl, and R⁴ is an alkyl group or an aryl group; and “b” and “c” are independently integers from and including 0 to the number of positions available for substitution on A¹ and A² respectively, provided b+c is greater than or equal to 1. One or more such activated aromatic carbonates may be used for forming the PC block of the PPE-PC block copolymers.

In one embodiment, the activated aromatic carbonate comprises an ester-substituted diaryl carbonate having the structure

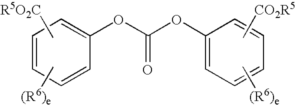

wherein R⁵ is independently at each occurrence a C₁-C₂₀ aliphatic radical, a C₄-C₂₀ cycloaliphatic radical, or a C₄-C₂₀ aromatic radical; R⁶ is independently at each occurrence a halogen, a cyano group, a nitro group, a C₁-C₂₀ alkyl group, a C₄-C₂₀ cycloalkyl group, a C₄-C₂₀ aromatic group, a C₁-C₂₀ alkoxy group, a C₄-C₂₀ cycloalkoxy group, a C₄-C₂₀ aryloxy group, a C₁-C₂₀ alkylthio group, a C₄-C₂₀ cycloalkylthio group, a C₄-C₂₀ arylthio group, a C₁-C₂₀ alkylsulfinyl group, a C₄-C₂₀ cycloalkylsulfinyl group, a C₄-C₂₀ arylsulfinyl group, a C₁-C₂₀ alkylsulfonyl group, a C₄-C₂₀ cycloalkylsulfonyl group, a C₄-C₂₀ arylsulfonyl group, a C₁-C₂₀ alkoxycarbonyl group, a C₄-C₂₀ cycloalkoxycarbonyl group, a C₄-C₂₀ aryloxycarbonyl group, a C₂-C₆₀ alkylamino group, a C₆-C₆₀ cycloalkylamino group, a C₅-C₆₀ arylamino group, a C₁-C₄₀ alkylaminocarbonyl group, a C₄-C₄₀ cycloalkylaminocarbonyl group, a C₄-C₄₀ arylaminocarbonyl group, and a C₁-C₂₀ acylamino group; and “e” is independently at each occurrence an integer from zero to 4.

Specific non-limiting examples of activated aromatic carbonates include, bis(o-chlorophenyl) carbonate, bis(o-nitrophenyl) carbonate, bis(o-acetylphenyl) carbonate, bis(o-phenylketonephenyl) carbonate, bis(o-formylphenyl) carbonate, and bis(methyl salicyl) carbonate. In a particular embodiment, the activated aromatic carbonate is bis(methyl salicyl) carbonate (CAS Registry No. 82091-12-1), hereinafter abbreviated as “BMSC”. BMSC can be readily prepared by reaction of methyl salicylate with phosgene in the presence of an acid scavenger, such as a trialkylamine (for example, triethylamine) in an inert solvent, such as dichloromethane. BMSC is also preferred since under the melt polymerization conditions used for producing the polycarbonate chain, since it has a lower molecular weight and a higher vapor pressure.

Activated aromatic carbonates comprise at least one activating group that renders the activated aromatic carbonate more reactive than diphenyl carbonate in transesterification reactions and many such activating groups are discussed herein. To provide greater clarity, it is helpful to provide examples of groups that do not activate an aromatic carbonate. Some non-limiting examples of such “non-activating groups” are alkyl groups and cycolalkyl groups. Diphenyl carbonate and aromatic carbonates lacking an activating group and comprising a non-activating group are referred to as “non-activated carbonates”. Some specific and non-limiting examples of non-activated carbonates include bis(o-methylphenyl) carbonate, bis(p-cumylphenyl) carbonate, bis(p-(1,1,3,3-tetramethyl)butylphenyl) carbonate and bis(o-isopropylphenyl) carbonate. Unsymmetrical combinations of these structures are also expected to result in non-activated carbonates.

As should be clear from this discussion, unsymmetrical activated aromatic carbonates comprising two aryl groups wherein one aryl group comprises an activated group and one aryl group comprises a non-activating group, may also serve as the activated carbonate.

As noted, one method for determining whether an aromatic carbonate is an activated aromatic carbonate is to carry out a model melt transesterification reaction between the particular aromatic carbonate and a phenol such as para-(1,1,3,3-tetramethyl)butyl phenol and compare the reaction rate observed with that observed for an identical reaction using diphenyl carbonate as the aromatic carbonate. In conducting these model reactions para-(1,1,3,3-tetramethyl)butyl phenol is often preferred because it has a single hydroxy group, has low volatility, and possesses a similar reactivity to bisphenol-A. The model melt transesterification reaction is carried out at a temperature above the melting points of the particular aromatic carbonate and phenol in the presence of a transesterification catalyst, which is usually an aqueous solution of sodium hydroxide or sodium phenoxide. Preferred concentrations of the transesterification catalyst are at about 0.001 mole percent based on the number of moles of the phenol or aromatic carbonate. Although a preferred reaction temperature is 200° C., the choice of reaction conditions as well as catalyst concentration can be adjusted depending on the reactivity and melting points of the reactants to provide a convenient reaction rate. The reaction temperature is preferably maintained below the degradation temperature of the reactants. Sealed tubes can be used if the reaction temperatures cause the reactants to volatilize and affect the reactant molar balance. A determination of an equilibrium concentration of the reactants is accomplished through reaction sampling during the course of the reaction with subsequent analysis of the reaction mixture. Reaction mixtures are conveniently assayed by HPLC (high pressure liquid chromatography). Particular care should be taken so that the reaction does not continue after the sample has been removed from the reaction vessel. This may be accomplished by cooling the sample in an ice bath and by employing a reaction quenching acid, such as acetic acid in the water phase of the HPLC solvent system. It may also be desirable to introduce the reaction quenching acid directly into the reaction sample in addition to cooling the reaction mixture. A preferred concentration for the reaction quenching acid, for example acetic acid in the water phase of the HPLC solvent system, is about 0.05 mole percent. The equilibrium constant is then determined from the concentration of the reactants and products after equilibrium is reached. Equilibrium is assumed to have been reached when the concentration of components in the reaction mixture reach a point of little or no change on sampling of the reaction mixture. The equilibrium constant can be determined from the concentration of the reactants and products by methods well known to those skilled in the art. An aromatic carbonate which possesses a relative equilibrium constant (K_{diarylcarbonate}/K_{diphenylcarbonate}) of greater than 1 is considered to be an activated aromatic carbonate, whereas an aromatic carbonate which possesses a relative equilibrium constant of 1 or less is considered to be a non-activated aromatic carbonate. It is generally preferred to employ an activated aromatic carbonate with very high reactivity in the model reaction compared to diphenyl carbonate when conducting transesterification reactions leading to polycarbonates. Preferred are activated aromatic carbonates with an equilibrium constant greater than at least 1,000 times that of diphenyl carbonate.

As noted, the poly(arylene ether)-polycarbonate (PPE-PC) block copolymer comprises structural units derived from an activated aromatic carbonate. Typically, these structural units include the carbonyl groups of the carbonate linkages of the PC blocks as well as the carbonyl groups of the carbonate groups through which the PC blocks and the PPE blocks are joined together. In addition, the product PPE-PC block copolymers may comprise other structural units derived from the activated aromatic carbonate. These structural units may be end groups incorporated into the polycarbonate block (PC block) or may be incorporated into the backbone of the polycarbonate block. The PC blocks comprising carbonate units derived from the activated carbonate preferably comprise at least one end group derived from the activated carbonate. In one embodiment, the end groups which are derived from the activated aromatic carbonate have structure

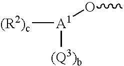

wherein A¹, Q³, R², “b” and “e” are defined as above.

Particularly when the polycarbonate block is prepared via melt polymerization of an ester-substituted aromatic carbonate, such as for example BMSC, with a dihydroxy aromatic compound (for example, BPA), the product PPE-PC block copolymer may further comprise very low levels of structural features, which arise from side reactions taking place during the melt polymerization reaction. One such structural feature has the structure

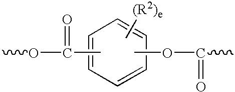

wherein R² and “e” are defined as in structure (IV). Note that “e” is an integer from and including 0 to 4, 4 being the maximum number of positions available for substitution. This structure is termed an “internal ester-carbonate linkage” or “kink”. Without wishing to be bound by any theory, it is thought that the structure may arise by reaction of an ester-substituted phenol by-product, for example methyl salicylate, at its ester carbonyl group with a dihydroxy aromatic compound or a hydroxy group of a growing polymer chain. Further reaction of the ester-substituted phenolic hydroxy group leads to formation of a carbonate linkage. Thus, the ester-substituted phenol by-product of reaction of an ester-substituted diaryl carbonate with a dihydroxy aromatic compound may be incorporated into the main chain of a linear polycarbonate, for example.

Another structural feature which may be present in polycarbonate prepared via a melt transesterification polymerization reaction between an ester-substituted aromatic carbonate and a dihydroxy aromatic compound is the ester-linked terminal end group having the structure

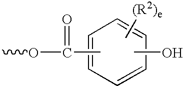

wherein R² and “e” are defined as for the previous structure. Without wishing to be bound by any theory, it is believed this structure may arise in the same manner as structure (VII), but without further reaction of the hydroxy group of the ester substituted phenol giving rise to this structure. In the structures provided herein, the wavy line represents the polycarbonate polymer chain structure.

End capping of the polymer chains formed during melt transesterification reactions such as those described herein, may be only partial. Typically, in polycarbonate systems related to the PPE-PC block copolycarbonates prepared by the methods described herein, the hydroxy group content may be from 7 percent to 50 percent of the total number of end groups present. In some embodiments, the percent endcapping may be at least about 90 percent. Although, not wishing to be bound by any theory, it is believed that polycarbonates formed during reactions that ultimately result in the formation of PPE-PC block copolymers are not completely endcapped and possess both hydroxy end groups and aryloxy end groups. When the activated aromatic carbonate employed is an ester-substituted activated aromatic carbonate the polycarbonates formed during reactions that ultimately result in the formation of PPE-PC block copolymers are believed to possess both hydroxy end groups and ester-substituted aryloxy end groups. In the preparation of polycarbonates the amounts of hydroxy end groups relative to the total number of end groups may be controlled. End groups identity and concentration may be varied by changing reaction conditions or by adding additional end-capping agents. In one embodiment, wherein the polycarbonate is prepared using the activated carbonate BMSC, ester-linked end group having the structure

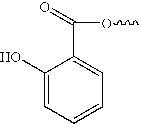

which possesses a hydroxy group may be present. The hydroxy group present in this structure can in principle take part in polycarbonate chain formation and copolymer formation. The chemistries observed in polycarbonate systems are believed to be substantially similar to those occurring in reaction mixtures that ultimately provide PPE-PC block copolymers.

In one embodiment, the polycarbonate block of the product PPE-PC block copolymer may comprise an end group having the structure

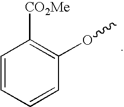

End groups having this structure are typically linked to the remaining portion of polycarbonate via a carbonate linkage. As such, end groups comprising this structure represent activated carbonate moieties susceptible to reaction with the hydroxy groups of the poly(arylene ether) component. When a polycarbonate comprising activated carbonate moieties reacts with the hydroxy groups of the poly(arylene ether) component a polymer comprising a poly(arylene ether) (PPE) block and a polycarbonate (PC) block results. Such processes are believed to account for the formation of the PPE-PC block copolymers described herein. Useful end groups include other salicyl groups such as the ethyl salicyl, isopropyl salicyl, and butyl salicyl groups.

The poly(arylene ether)-polycarbonate block copolymers may further comprise structural units derived from an endcapping agent not derived from the activated aromatic carbonate. Endcapping agents are generally used to control the molecular weight of the polycarbonates. Suitable endcapping agents include phenol, and monoalkyl-substituted or monoaryl-substituted phenols, such as para-cumylphenol, para-cresol, and the like. It will be understood that the term “endcapping agent” does not include polymeric species, such as a poly(arylene ether) having a single hydroxy group, or a polycarbonate having a single reactive endgroup.

In an embodiment, a specific poly(arylene ether)-polycarbonate block copolymer (referred to hereinafter for convenience as “Composition A”) comprises structural units derived from: (A) a hydroquinone selected from the group consisting of 1,4-hydroquinone and 2-methyl-1,4-hydroquinone, (B) a poly(2,6-dimethyl-1,4-phenylene ether) comprising a hydroxy group; (C) bisphenol A, and (D) an activated aromatic carbonate. In one embodiment, the block copolymer comprises structural units derived from 1,4-hydroquinone and bisphenol A, and greater than or equal to 60 mole percent of those units are from 1,4-hydroquinone. In one embodiment, Composition A comprises structural units derived from 2-methyl-1,4-hydroquinone and bisphenol A and optionally 1,4-hydroquinone, wherein greater than or equal to about 94 mole percent of the structural units are derived from methyl-1,4-hydroquinone. In another embodiment, Composition A comprises structural units derived from 1,4-hydroquinone, 2-methyl-1,4-hydroquinone, and bisphenol A wherein greater than or equal to about 97 mole percent of the structural units are derived from of 1,4-hydroquinone and 2-methyl-1,4-hydroquinone. In still other embodiments, the block copolymer may comprise about 6 to 60 weight percent, or about 30 to about 50 weight percent, of structural units derived from a poly(2,6-dimethyl-1,4-phenylene ether), based on a total weight of the block copolymer. In another specific embodiment, a PPE-PC block copolymer comprises the structural units described for “Composition A”, wherein the activated aromatic carbonate is BMSC.

In still another embodiment, a specific PPE-PC block copolymer is provided, which comprises structural units derived from: (A) a hydroquinone selected from the group consisting of 1,4-hydroquinone and 2-methyl-1,4-hydroquinone; (B) a poly(2,6-dimethyl-1,4-phenylene ether) comprising a hydroxy group; (C) bisphenol A; and (D) bis(methyl salicyl) carbonate. In some embodiments, the PPE-PC block copolymer is melt crystalline.

The structure of the poly(arylene ether)-polycarbonate block copolymer may take a variety of forms. For example, the poly(arylene ether)-polycarbonate block copolymer may be a diblock copolymer, a triblock copolymer, a linear multiblock copolymer having more than three blocks, or a radial teleblock copolymer. In one embodiment, the poly(arylene ether)-polycarbonate block copolymer is a poly(arylene ether)-polycarbonate-poly(arylene ether) triblock copolymer. The block architecture of the copolymer may be controlled via the number of hydroxy groups on the poly(arylene ether), the number of hydroxy groups on the polycarbonate, the ratio of moles of activated carbonate to total moles of hydroxy groups on the poly(arylene ether) and polycarbonate, the use of an endcapping agent, as well as other reaction conditions.

One embodiment is a general methodology for the preparation of PPE-PC block copolymers. Thus, one embodiment is a general and efficient method for the preparation of PPE-PC block copolymers that may be amorphous or crystalline. In this embodiment, PPE-PC block copolymers may be prepared by heating a mixture comprising a polycarbonate, a poly(2,6-dimethyl-1,4-phenylene ether) comprising a hydroxy group, and an activated aromatic carbonate, in the presence of a transesterification catalyst, at one or more temperatures in a temperature range of about 100 to about 400° C. There is no particular limitation on the composition of the polycarbonate and any polycarbonate comprising at least one reactive hydroxy group (for example, a BPA polycarbonate comprising aromatic hydroxy end groups) may be employed. In addition, PPE-PC block copolymers may be prepared by heating a mixture comprising a dihydroxy aromatic compound, a poly(2,6-dimethyl-1,4-phenylene ether) comprising a hydroxy group, and an activated aromatic carbonate in the presence of a transesterification catalyst, at one or more temperatures in a temperature range of about 100 to about 400° C.

Another embodiment is a general and efficient method for the preparation of the melt crystalline PPE-PC block copolymers. In this embodiment, melt crystalline PPE-PC block copolymers may be prepared by heating a mixture comprising a poly(2,6-dimethyl-1,4-phenylene ether) comprising a hydroxy group, an activated aromatic carbonate, and a polycarbonate, the polycarbonate comprising structural units derived from a hydroquinone, in the presence of a transesterification catalyst, at one or more temperatures in a temperature range of about 100 to about 400° C. In addition, the melt crystalline PPE-PC block copolymers may be prepared by heating a mixture comprising a poly(2,6-dimethyl-1,4-phenylene ether) comprising a hydroxy group, an activated aromatic carbonate, and a 1,4-hydroquinone selected from the group consisting of 1,4-hydroquinone and methyl-1,4-hydroquinone, in the presence of a transesterification catalyst, at one or more temperatures in a temperature range of about 100 to about 400° C. In some embodiments, the mixture is subjected to melt mixing in an extruder equipped with a vent adapted for removal of a volatile component. Alternatively, the block copolymers may be prepared by using any polymerization reactor generally used for producing polycarbonates by the melt polymerization process. The polymerization can also be carried out in the presence of a suitable solvent. For example, a mixture comprising a solution of a polycarbonate, a poly(arylene ether) comprising a hydroxy group, and an activated aromatic carbonate in a solvent is extruded through an extruder adapted to remove the solvent to provide the block copolymers.

In one embodiment, a mixture fed to the extruder may comprise about 10 weight percent to about 99 weight percent of a solvent, and in another embodiment about 30 weight percent to about 70 weight percent, of solvent. Non-limiting examples of suitable solvents include ester-substituted phenols, halogenated aromatic solvents, halogenated aliphatic solvents, non-halogenated aromatic solvents, non-halogenated aliphatic solvents, and mixtures thereof. Halogenated aromatic solvents are illustrated by ortho-dichlorobenzene (ODCB), chlorobenzene, and the like. Non-halogenated aromatic solvents are illustrated by toluene, xylene, anisole, phenol, 2,6-dimethylphenol, and the like. Halogenated aliphatic solvents are illustrated by methylene chloride, chloroform, 1,2-dichloroethane, and the like. Non-halogenated aliphatic solvents are illustrated by ethanol, acetone, ethyl acetate, cyclohexanone, and the like. In one embodiment, the solvent employed comprises a mixture of a halogenated aromatic solvent and an ester substituted phenol, such as for example, a mixture of ortho-dichlorobenzene (ODCB) and methyl salicylate.

The solvent may also comprise a monohydroxy aromatic compound by-product resulting from the reaction of the activated aromatic carbonate with the aromatic hydroxy groups of a dihydroxy aromatic compound. For example, reaction of bisphenol A or mixtures of bisphenol A, a hydroquinone, and a poly(arylene ether) having a hydroxy group with bis(methyl salicyl) carbonate (BMSC) produces 2-methoxycarbonylphenol (methyl salicylate) as a by-product, which acts as the solvent component. In another embodiment, a monohydroxy aromatic compound produced as a by-product during the formation of the oligomeric polycarbonate from a dihydroxy aromatic compound and an activated aromatic carbonate is the only solvent present during the formation of the melt crystalline PPE-PC block copolymer.

Hydroxy substituted polycarbonates, such as for example, a bisphenol A polycarbonate comprising hydroxy end groups, may be obtained by any of a number of known methods, such as solution polymerization (for example by reaction of dihydroxy aromatic compounds with bis(chloroformates) of dihydroxy aromatic compounds), or melt polymerization (for example, by melt polymerization of bisphenol A with diphenyl carbonate in the presence of a transesterification catalyst to provide a hydroxy-terminated bisphenol A polycarbonate). The polycarbonate comprises terminal hydroxy groups, which can participate in the formation of a block copolymer upon reaction with the poly(arylene ether) comprising a hydroxy group in the presence of an activated aromatic carbonate. In addition to PPE-PC block copolymer formation, the method may also result in (i) conversion of a polycarbonate to a polycarbonate having higher molecular weight (via coupling of polycarbonate chains), and (ii) separation of a solvent from the product PPE-PC block copolymer. In some embodiments, the method provides for the removal of other volatile materials that may be present in the initial feed solution, or formed as by-products as the reaction components are transformed to the product PPE-PC block copolymer.

Although the precise order of the reactions leading to PPE-PC block copolymer formation is unknown, it is convenient to describe the overall process in terms of a two part reaction model involving (1) a first stage in which the reactants are heated together to form an “equilibrated” mixture comprising a polycarbonate comprising activated terminal aryloxy groups, a poly(arylene ether) comprising a hydroxy group, and a by-product phenolic compound arising from transesterification of the activated aromatic carbonate; and (2) a second stage in which the by-product phenolic compound is removed and polymer chain growth and copolymer formation occur to afford the product PPE-PC block copolymers. It will be understood by those skilled in the art that the reactions leading to PPE-PC block copolymers described herein are more complex than this simple model. Thus the “equilibrated” mixture of the first stage may well comprise oligomeric PPE-PC block copolymers that are transformed into high molecular weight PPE-PC block copolymers in the second stage of the reaction. Further, the polycarbonate present in the equilibrated reaction mixture may comprise hydroxy groups and the poly(arylene ether) oligomer may comprise activated terminal aryloxy groups linked to the poly(arylene ether) oligomer structure through a carbonyl group (the poly(arylene ether) is terminated by an activated carbonate moiety). In the second stage of the reaction the hydroxy groups of the polycarbonate may displace the activated terminal aryloxy groups of the poly(arylene ether) to afford PPE-PC block copolymer. Thus when reference is made herein to a polycarbonate formed in an equilibration reaction in which a poly(arylene ether) comprising a hydroxy group is present as a reactant, it will be understood that the polycarbonate may comprise either terminal hydroxy groups or terminal activated aryloxy groups, or the polycarbonate may in fact comprise an oligomeric PPE-PC block copolymer.

Typically, the equilibration step involves heating the hydroquinone, the poly(arylene ether) component, and the optional aromatic dihydroxy compound with an ester substituted diaryl carbonate in the presence of a transesterification catalyst. Thus, the reactants are combined in a vessel in a ratio of about 0.5 to about 2 moles of activated aromatic carbonate per mole of dihydroxy compounds present. Within this range, the ratio may be at least about 0.75, or at least about 0.95, or at least about 1; also within this range, the ratio may be up to about 1.5, or up to about 1.3, or up to about 1.2, or up to about 1.1, or up to about 1.05. The amount of transesterification catalyst employed is about 1.0×10⁻⁸ to about 1×10⁻³, or about 1.0×10⁻⁶ to about 2.5×10⁻⁴, moles of transesterification catalyst per mole of dihydroxy compounds present. Upon heating the mixture at one or more temperatures in a range of about 100 to about 400° C., or about 100 to about 300° C., or about 100 to about 250° C., reaction occurs to produce a solution comprising an equilibrium mixture of product polycarbonate, by-product ester substituted phenol (solvent), transesterification catalyst, and low levels of the starting materials, dihydroxy aromatic compound, and activated aromatic carbonate. This is referred to as “equilibrating” the reactants. Typically the equilibrium strongly favors the formation of product polycarbonate and by-product substituted phenol (derived from the activated aromatic carbonate), and only traces of the starting materials are observed. The product polycarbonate comprises terminal ester-substituted phenoxy carbonyl groups that serve as sites for PPE-PC block copolymer formation via reaction with the hydroxy group(s) of the poly(arylene ether). In one embodiment, the polycarbonate produced has a number average molecular weight of greater than or equal to about 500 atomic mass units. In one embodiment, the polycarbonate produced has a number average molecular weight of greater than or equal to about 5000 atomic mass units.

Typically, the amount of catalyst present during the second stage of the reaction will closely approximate the amount of catalyst used in the equilibration step. It should be noted that in one embodiment a polycarbonate is prepared using a method such as interfacial polymerization. In this embodiment, the polycarbonate, the poly(arylene ether) comprising a hydroxy group, and the activated aromatic carbonate are heated together in the melt to provide a PPE-PC block copolymer. Under such circumstances, there is no equilibration step involved and addition of an exogenous catalyst may be required in order to effect PPE-PC block copolymer formation. In one embodiment, a polycarbonate, the poly(arylene ether) comprising a hydroxy group, the catalyst and the activated diaryl carbonate are combined in an extruder to provide upon extrusion the PPE-PC block copolymer. In some embodiments, the catalyst may be added prior to the extrusion step, during the extrusion step, or both.

In some instances it may be desirable to remove a portion of the ester-substituted phenol by-product formed during the equilibration of the reactants. This may be done conveniently by heating the reactants and the transesterification catalyst under vacuum, typically a pressure of about 0.01 to about 0.9 atmosphere, and distilling off a portion of the ester-substituted phenol. As ester-substituted phenol is distilled from the mixture undergoing the equilibration reaction, the molecular weight of the polycarbonate will tend to increase. If sufficient ester substituted phenol by-product is removed, the number average molecular weight (Mn) of the oligomeric polycarbonate may be in excess of 5,000 AMU and in some instances in excess of 7,000 AMU. Thus, in one embodiment, a mixture comprising the reactants is heated in the presence of a transesterification catalyst at a temperature of about 100 to about 300° C., and a portion of the by-product ester substituted phenol is removed by distillation to provide an equilibration product mixture comprising a substituted phenol, a transesterification catalyst, and a polycarbonate, the polycarbonate comprising terminal substituted phenoxy carbonyl groups. In one embodiment, this equilibration product mixture is fed to the devolatilizing extruder and extruded to provide a PPE-PC block copolymer.

In one embodiment, the mixture fed to the extruder for preparing the PPE-PC block copolymer comprises a transesterification catalyst, a hydroquinone, a poly(arylene ether) comprising a hydroxy group, an activated aromatic carbonate, and optionally one or more dihydroxy aromatic compounds other than the hydroquinone. The activated aromatic carbonate may be employed in an amount of about 0.95 to about 1.05 moles per mole of a combination of the hydroquinone, the poly(arylene ether), and the dihydroxy aromatic compound. The mixture is heated to suitable temperatures in a range of about 100 to about 400° C. to effect formation of the block copolymer. The by-product phenolic compound formed during the course of the reaction may be removed by conventional techniques, such as distillation at ambient or sub-ambient pressures.

As noted, in one embodiment an extruder is used to prepare the PPE-PC bock copolymer. The extruder may be a devolatilizing extruder. That is, it is an extruder adapted for separating substantial amounts of volatile components from a polymer-containing mixture. Therefore the extruder must possess at least one, and preferably more than one, vent adapted for removal of volatiles.

The devolatilizing extruder may be a single-screw or multiple-screw extruder. Typically, the devolatilizing extruder is operated at one or more temperatures in a range of about 100 to about 400° C., and at one or more screw speeds in a screw speed range of about 50 to about 1200 rpm, or about 50 to about 500 rpm.

Suitable devolatilizing extruders include co-rotating intermeshing double-screw extruders, counter-rotating non-intermeshing double-screw extruders, single-screw reciprocating extruders, and single-screw non-reciprocating extruders.

Extruder screw speed and feed rate are typically interdependent. It is useful to characterize this relationship between feed rate and screw speed as a ratio. Typically the extruder is operated such that the ratio of starting material introduced into the extruder in pounds per hour to the screw speed expressed in rpm falls within a range of about 0.0045 to about 45 kilograms per hour per rpm (about 0.01 to about 100 pounds per hour per rpm), or 0.0023 to about 2.3 kilograms per hour per rpm (about 0.05 to about 5 pounds per hour per rpm). For example, the ratio of feed rate to screw speed where a solution is being introduced at 454 kilograms per hour (1000 pounds per hour) into an extruder being operated at 400 rpm is 1.13 kilograms per hour per rpm (2.5 pounds per hour per rpm). The maximum and minimum feed rates and extruder screw speeds are determined by, among other factors, the size of the extruder, the general rule being the larger the extruder the higher the maximum and minimum feed rates.

In one embodiment, a feed mixture comprising a transesterification catalyst, a hydroquinone, a poly(arylene ether) comprising a hydroxy group, an activated aromatic carbonate, and optionally one or more dihydroxy aromatic compounds other than the hydroquinone is prepared in a reaction vessel and heated at a temperature of about 100 to about 300° C., or about 150 to about 250° C., at a pressure of about 1 to about 10 atmospheres, or about 1 to about 2 atmospheres, to provide a solution of the products of equilibration, the phenolic by-product formed in transesterification reactions of the activated aromatic carbonate serving as the solvent. In some embodiments, the phenolic by-product is an ester-substituted phenol, for example methyl salicylate. The resulting solution may be transferred by means of a gear pump into an extruder, for example a fourteen-barrel, vented, twin-screw extruder. The extruder may be of any suitable screw design suitable to facilitate movement of materials and sufficient residence time to effect removal of the solvent (ester-substituted phenol) and complete the formation of the PPE-PC block copolymer. The extruder screw design consists of conveying screw elements and mixing sections, which include an initial mixing section and one or more mixing zones, which provide for intense mixing of the contents of the extruder. The extruder is operated at about 100 to about 400° C., or about 200 to about 350° C., at a screw speed of about 50 to about 1200 rpm. The solution is introduced into the upstream portion of the extruder barrel. The extruder is equipped with vents (operated at atmospheric or sub-atmospheric pressure), which are connected to a manifold system for removal of the ester-substituted phenol solvent and other volatile by-products formed during the formation of the PPE-PC block copolymer. The resulting PPE-PC block copolymer is isolated as an extrudate.

In some embodiments, the reactant mixture employed comprises a chain stopper, such as a mono-functional monohydroxy aromatic compound, example phenol, para-cumyl phenol, or the like.

As noted, the equilibrated mixture fed to the extruder may optionally contain one or more solvents. In one embodiment, an equilibrated mixture of the comprising a solvent is heated under pressure to produce a “superheated” solution, meaning that the temperature of the superheated solution is greater than the boiling point of the solvent at atmospheric pressure. Typically, the temperature of the superheated solution will be about 2 to about 200° C. higher than the boiling point of the solvent at atmospheric pressure. In instances where there are multiple solvents present, the solution is “superheated” with respect to at least one of the solvent components. Where the solution contains significant amounts of both high and low boiling solvents, it may be advantageous to superheat the solution with respect to all solvents present (that is, above the boiling point at atmospheric pressure of the highest boiling solvent). Superheating may be achieved by heating the solution mixture under pressure, typically at a pressure up to about 10 atmospheres but greater than one atmosphere. Such superheated solutions are conveniently prepared in pressurized heated feed tanks, pressurized heat exchangers, extruders, pressurized reaction vessels and the like. The superheated solution is then introduced into a devolatilizing extruder through a pressure control valve. In one embodiment of the devolatilizing extruder is equipped with at least one side feeder. In another embodiment, the extruder in combination with the side feeder is equipped with one or more atmospheric vents in close proximity to the principal feed inlet comprising the pressure control valve.

In some instances, it may be found that the product PPE-PC block copolymer is of insufficient molecular weight, or retains too much solvent or other volatile by-products generated during the formation of the block copolymer. In such instances, the product obtained may be subject to a second extrusion on the same or a different devolatilizing extruder to furnish a PPE-PC block copolymer with an increased molecular weight and a reduced level of residual solvent and/or volatile reaction by-products.

One embodiment is a method for producing a poly(arylene ether)-polycarbonate block copolymer, the method comprising: heating in the presence of a transesterification catalyst, a mixture comprising a hydroquinone; a poly(arylene ether) comprising a hydroxy group; optionally one or more dihydroxy aromatic compounds other than the hydroquinone; and an activated aromatic carbonate at a temperature in a range of about 100 to about 300° C. to provide a solution comprising a polycarbonate, a poly(arylene ether), and a solvent derived from the activated aromatic carbonate; and extruding the solution at one or more temperatures in a range of about 100 to about 400° C., and at one or more screw speeds in a range of about 50 to about 1200 rpm, the extruding being carried out on an extruder comprising a vent adapted for solvent removal, to provide a poly(arylene ether)-polycarbonate block copolymer.

The method may be carried out in a batch or continuous mode. In one embodiment, the method is carried out as a batch process wherein the reactants is equilibrated in a batch reactor to form a solution comprising the products of equilibration of the feed components. This solution is then fed to a devolatilizing extruder and the product PPE-PC block copolymer is isolated at the outlet end of the extruder. Alternatively, the method may be carried out continuously, wherein the reactants are continuously fed into a continuous reactor, and the resultant solution comprising the products of equilibration of the feed components is continuously fed into a devolatilizing extruder from which emerges the product PPE-PC block copolymer.

It is understood, especially for melt reactions, that purity of the reactants, namely the monomers (the hydroquinone, the activated aromatic carbonate, and the dihydroxy aromatic compounds) and the polymers (the polycarbonate and the poly(arylene ether) having a hydroxy group) employed may strongly affect the properties of the product PPE-PC block copolycarbonate. Thus, it is frequently desirable that the feed components employed be free of, or contain only very limited amounts of, contaminants such as metal ions, halide ions, acidic contaminants and other organic species. Typically the concentration of metal ions, for example iron, nickel, cobalt, sodium, and potassium, present in the monomer should be less than about 10 parts per million by weight (ppm), or less than about 1 ppm, or less than about 100 parts per billion by weight (ppb). The amount of halide ions, for example fluoride, chloride and bromide ions, should be minimized in order to avoid the corrosive effects of halide ion on equipment used in the preparation of the PPE-PC block copolymer. Preferably, the level of halide ion present in each feed component employed should be less than about 1 ppm. The presence of acidic impurities, for example organic sulfonic acids, which may be present in bisphenols such as BPA, should be minimized since only minute amounts of basic catalysts are employed in the oligomerization and subsequent polymerization steps. Even a small amount of an acidic impurity may have a large effect on the rate of oligomerization and polymerization since it may neutralize a substantial portion of the basic catalyst employed. Lastly, the tendency of polycarbonates to degrade at high temperature, for example during molding, with concomitant loss of molecular weight and discoloration correlates strongly with the presence of contaminating species within the polycarbonate block of the block copolymer. In general, the level of purity of a product PPE-PC block copolymer prepared using a melt reaction method will closely mirror the level of purity of the starting feed components.

Because, the transesterification catalyst is typically neither consumed in the equilibration step nor removed prior to extrusion, there is typically no need to add additional catalyst during extrusion. The transesterification catalyst may be any catalyst effective in promoting a typical melt reaction of a bisphenol such as BPA with a diaryl carbonate such as diphenyl carbonate to form a polycarbonate. The transesterification catalysts may comprise onium catalysts such as a quaternary ammonium compound, a quaternary phosphonium compound, or a mixture thereof. Quaternary onium hydroxides, halides, carboxylates, phenoxides, sulfonates, sulfates, carbonates, and bicarbonates may be used as catalysts. Illustrative, non-limiting examples of quaternary ammonium compounds include tetamethylammonium hydroxide, tetrabutylammonium acetate, tetrabutylammonium hydroxide, and the like, and mixtures thereof. Non-limiting examples of quaternary phosphonium compounds include tetamethylphosphonium hydroxide, tetrabutylphosphonium acetate, tetrabutylphosphonium hydroxide, and the like, and mixtures thereof.

In one embodiment, the transesterification catalyst used is a combination of a quaternary ammonium compound, a quaternary phosphonium compound, or a mixture thereof, with an alkali metal hydroxide, an alkaline earth metal hydroxide, or a mixture thereof. For example, a mixture of tetrabutylphosphonium acetate and sodium hydroxide can be used.

Other transesterification catalysts that may be used include one or more alkali metal salts of carboxylic acids, one or more alkaline earth salts of a carboxylic acid, and mixtures thereof. Such transesterification catalysts are illustrated by simple salts of carboxylic acids, such as sodium acetate, calcium stearate and the like. Additionally, alkali metal and alkaline earth metal salts of organic polyacids may serve as efficient transesterification catalysts. Alkali metal and alkaline earth metal salts of organic polyacids, such as ethylene diamine tetracarboxylate, may be employed. Salts of organic polyacids are illustrated by disodium magnesium ethylenediamine tetraacetate (Na₂Mg EDTA).

In one embodiment, the transesterification catalyst comprises a salt of a non-volatile acid. By “non-volatile” it is meant that the acid from which the catalyst is made has no appreciable vapor pressure under melt polymerization conditions. Examples of non-volatile acids include phosphorous acid, phosphoric acid, sulfuric acid, and metal “oxo acids” such as the oxo acids of germanium, antimony, niobium, and the like. Salts of non-volatile acids useful as melt polymerization catalysts include alkali metal salts of phosphites, alkaline earth metal salts of phosphites, alkali metal salts of phosphates, alkaline earth metal salts of phosphates, alkali metal salts of sulfates, alkaline earth metal salts of sulfates, alkali metal salts of metal oxo acids, and alkaline earth metal salts of metal oxo acids. Specific examples of salts of non-volatile acids include NaH₂PO₃, NaH₂PO₄, Na₂HPO₄, KH₂PO₄, CsH₂PO₄, Cs₂HPO₄, NaKHPO₄, NaCsHPO₄, KCsHPO₄, Na₂SO₄, NaHSO₄, NaSbO₃, LiSbO₃, KSbO₃, Mg(SbO₃)₂, Na₂GeO₃, K₂GeO₃, Li₂GeO₃, MgGeO₃, Mg₂GeO₄, and mixtures thereof.

In one embodiment the transesterification catalyst is employed in an amount of about 1.0×10⁻⁸ to about 1×10⁻³, or about 1.0×10⁻⁶ to about 2.5×10⁻⁴ moles of transesterification catalyst per mole of activated aromatic carbonate employed.

One embodiment is a method of preparing a poly(arylene ether)-polycarbonate block copolymer, comprising melt reacting a poly(arylene ether), a polycarbonate comprising structural units derived from a hydroquinone, and an activated aromatic carbonate.

In embodiments in which the PPE-PC block copolymers are melt crystalline, they possess an advantageous combination of processability and high melting temperature. In one embodiment, the PPE-PC block copolymers have a glass transition temperature of about 95 to about 140° C., and a melting temperature of about 260 to about 330° C. In one embodiment, the PPE-PC block copolymers have a glass transition temperature of about 110 to about 140° C., and a melting temperature of about 260 to about 300° C. Melt processability enables these block copolymers to be processed using conventional molding equipment for preparing a variety of molded articles. The high melting temperature bestows other valuable properties, such as chemical resistance and/or solvent resistance, which makes them useful for producing articles useful in aeronautical and automotive under-the-hood applications, and as a storage medium for chemicals. Further, the melt crystalline block copolymers are valuable for producing articles useful in the healthcare industry, such as, for example, packaging pharmaceutical and healthcare products, and producing medical devices. In some embodiments, the PPE-PC block copolymers are essentially opaque. One of skill in the art will appreciate that the properties of the block copolymers can be varied by varying the structure of the hydroquinone monomer, the structure and/or molecular weight of the poly(arylene ether), the structure and/or molecular weight of the polycarbonate, and the type of activated aromatic carbonate. Likewise, the properties of the block copolymers can also be varied by varying the structure of the hydroquinone monomer, the structure and/or molecular weight of the poly(arylene ether), the structure and/or molecular weight of the dihydroxy aromatic compound(s) used for producing the polycarbonate, and the type of activated aromatic carbonate. In other embodiments, the PPE-PC block copolymers possess a combination of properties comprising one or more of an excellent impact strength, low water absorption, and good processability, making them suitable materials for producing robust articles that can withstand high temperatures and/or humid environments.

The PPE-PC block copolymers may be used as the base substrate for optical data storage media, that is, they may function as the substrate onto which a data storage medium can be applied.

One embodiment is a method for producing a poly(arylene ether)-polycarbonate block copolymer, the method comprising heating in the presence of a transesterification catalyst, at one or more temperatures in a temperature range of about 100 to about 400° C., a mixture comprising: (A) a polycarbonate; (B) a poly(arylene ether) comprising a hydroxy group; and (C) an activated aromatic carbonate. This method may, optionally, be carried out on an extruder equipped with a vent adapted for removal of a volatile compound.

One embodiment is a method for producing a poly(arylene ether)-polycarbonate block copolymer, the method comprising heating in the presence of at a transesterification catalyst, at one or more temperatures in a temperature range of about 100 to about 400° C., a mixture comprising (A) a hydroquinone; (B) a poly(arylene ether) comprising a hydroxy group; (C) a dihydroxy aromatic compound other than the hydroquinone; and (D) an activated aromatic carbonate. The mixture may, optionally further comprise about 10 to about 99 percent by weight of a solvent selected from the group consisting of ester-substituted phenols, halogenated aromatic solvents, halogenated aliphatic solvents, non-halogenated aliphatic solvents, and mixtures thereof.

One embodiment is a method of preparing a poly(arylene ether)-polycarbonate block copolymer, comprising melt reacting a poly(arylene ether), a polycarbonate comprising structural units derived from a hydroquinone, and an activated aromatic carbonate. Note that the polycarbonate need not be synthesized as part of the procedure to prepare the block copolymer. In other words, a polycarbonate prepare separately or purchased may be used in this method of forming a block copolymer.

One embodiment is a poly(arylene ether)-polycarbonate block copolymer comprising a poly(arylene ether) block, a polycarbonate block comprising units derived from a hydroquinone, and a carbonate group linking the poly(arylene ether) block and the polycarbonate block.

Poly(Arylene Ether)-Poly(Alkylene Ether) Block Copolymers

One embodiment is a method of preparing a poly(arylene ether)-poly(alkylene ether) block copolymer, comprising reacting a poly(arylene ether) comprising a hydroxy group, a poly(alkylene ether) comprising a hydroxy group, and an activated aromatic carbonate. The reaction can occur in a polymer melt (that is, in the absence of intentionally added solvent), or in solution (that is, in the presence of an intentionally added solvent). Suitable solvents for solution reactions include aromatic hydrocarbon solvents (for example, benzene, toluene, ethylbenzene, xylenes), halogenated aromatic hydrocarbon solvents, (for example, chlorobenzene, dichlorobenzenes, and trichlorobenzenes), and halogenated aliphatic hydrocarbon solvents (for example, methylene chloride, chloroform, carbon tetrachloride, dichloroethanes, dichloroethylenes, trichloroethanes, and trichloroethylene).

The term “melt reacting” refers to a reaction conducted in the absence of added solvent. (It will be understood that melt reactions encompass reactions that generate products that may act as solvents. For example, a melt reaction of bis(methyl salicyl) carbonate may generate methyl salicylate.) Melt reaction conditions generally include a temperature that is above the melting and/or glass transition temperatures of the poly(arylene ether) and poly(alkylene ether) reactants, but below a temperature at which those reactants are substantially unstable. The melt reaction may be conducted by blending the poly(arylene ether), the poly(alkylene ether), and the activated aromatic carbonate before heating to a temperature suitable for melt reaction. Alternatively, the activated aromatic carbonate may be melt reacted with either the poly(arylene ether) or the poly(alkylene ether) before the other polymer is added. In some embodiments, melt reaction conditions include one or more of the following process conditions: one or more temperatures in the range of about 90 to about 400° C., removal of volatile components using a vacuum of about 1 to 100 kilopascals, and agitation (for example stirring at about 1 to 100 rpm). Representative melt reaction conditions are described in detail in the working examples, below.

The poly(arylene ether) and the activated aromatic carbonate are the same as those described above in the context of the poly(arylene ether)-polycarbonate block copolymer.

The poly(alkylene ether) may comprise repeating units having the structure

R^{7—O*}

wherein R⁷ is a C₂-C₁₂ alkylene group, and the asterisks signify points of attachment to the remainder of the poly(alkylene ether) molecule. The poly(alkylene ether) may be linear or branched. It may have one or more than one hydroxy group.

In some embodiments, the poly(alkylene ether) has the structure

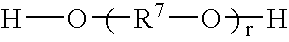

wherein R⁷ is a C₂-C₁₂ alkylene group, and r is 2 to about 1,000. Within the range of 2 to about 1,000, r may be at least about 10, or at least about 20, or at least about 40. Also within the range of 2 to about 1,000, r may be up to about 500, or up to about 200. In some embodiments, the poly(alkylene ether) has a number average molecular weight of about 100 to about 40,000 atomic mass units. Within this range, the number average molecular weight may be at least about 500, or at least about 1,000, or at least about 2,000 atomic mass units; also within this range, the number average molecular weight may be up to about 20,000, or up to about 10,000 atomic mass units. In some embodiments, R⁷ is an unsubstituted alkylene group. For example, it does not comprise a hydroxy group or any other heteroatom-containing group. Suitable poly(alkylene ether)s include, for example, polyethylene glycol, polypropylene glycol, polytetramethylene glycol, polyhexamethylene glycol, copolymeric glycols comprising at least two of ethyleneoxy units and propyleneoxy units and tetramethylene oxy units and hexamethyleneoxy units, and the like, and mixtures thereof. In one embodiment, the poly(alkylene ether) is polyethylene glycol, polytetramethylene glycol, or a mixture thereof.

In some embodiments, the activated aromatic carbonate may be used in an amount of about 0.5 to about 2 moles per two moles of total hydroxy groups contributed by the poly(arylene ether) and the poly(alkylene ether). Within this range, the activated aromatic carbonate amount may be at least about 0.75 mole, or at least about 0.95 mole, or at least about 1 mole per two moles of hydroxy groups. Also within this range, the activated aromatic carbonate amount may be up to about 1.5 moles, up to about 1.3 moles, up to about 1.2 moles, or up to 1.1 moles, or up to 1.05 moles, per two moles of hydroxy groups.

There is no particular limit on the weight ratio of poly(arylene ether) and poly(alkylene ether) used in the reaction mixture or incorporated into the resulting copolymer. In one embodiment, the weight ratio of the poly(arylene ether) to the poly(alkylene ether) is about 1:10 to about 10:1. Within this range, the weight ratio may be at least about 1:5, or at least about 1:4. Also within this range, the weight ratio may be up to about 2:1, or up to about 1:1.

The structure of the poly(arylene ether)-poly(alkylene ether) block copolymer may take a variety of forms. For example, the poly(arylene ether)-poly(alkylene ether) block copolymer may be a diblock copolymer, a triblock copolymer, a linear multiblock copolymer having more than three blocks, or a radial teleblock copolymer. In one embodiment, the poly(arylene ether)-poly(alkylene ether) block copolymer is a poly(arylene ether)-poly(alkylene ether)-poly(arylene ether) triblock copolymer. The block architecture of the copolymer may be controlled via the number of hydroxy groups on the poly(arylene ether), the number of hydroxy groups on the poly(alkylene ether), the ratio of moles of activated carbonate to total moles of hydroxy groups on the poly(arylene ether) and poly(alkylene ether), the use of an endcapping agent, as well as other reaction conditions. For example, when the poly(arylene ether) is predominantly monofunctional (that is, it has, on average, close to one hydroxy group per molecule) and the poly(alkylene ether) has, on average, close to two hydroxy groups per molecule, the reaction products may include a poly(arylene ether)-poly(alkylene ether)-poly(arylene ether) triblock copolymer.

One embodiment is a method of preparing a poly(arylene ether)-poly(alkylene ether) block copolymer, comprising melt reacting a poly(arylene ether) comprising a hydroxy group, a poly(alkylene ether) comprising a hydroxy group, and bis(methyl salicyl) carbonate; wherein the poly(arylene ether) has an intrinsic viscosity of about 0.04 to about 0.2 deciliters per gram at 25° C. in chloroform and comprises 2,6-dimethyl-1,4-phenylene ether units, 2,3,6-trimethyl-1,4-phenylene ether units, or a combination thereof; wherein the poly(alkylene ether) has a number average molecular weight of about 1,000 to about 10,000 atomic mass units, and wherein the poly(alkylene ether) is selected from the group consisting of polyethylene glycols, polytetramethylene glycols, and mixtures thereof; wherein the weight ratio of the poly(arylene ether) to the poly(alkylene ether) is about 1:5 to about 2:1; and wherein the activated aromatic carbonate is used in an amount of about 0.5 to about 2 moles per two moles of total hydroxy groups contributed by the poly(arylene ether) and the poly(alkylene ether).

One embodiment is a poly(arylene ether)-poly(alkylene ether) block copolymer prepared by any of the above-described methods.

One embodiment is a poly(arylene ether)-poly(alkylene ether) block copolymer comprising a poly(arylene ether) block, a poly(alkylene ether) block, and a carbonate group linking the poly(arylene ether) block and the poly(alkylene ether) block.

One embodiment is a poly(arylene ether)-poly(alkylene ether) block copolymer, comprising: a poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; a poly(alkylene ether) block having a number average molecular weight of about 1,000 to about 10,000 atomic mass units, wherein the poly(alkylene ether) is selected from the group consisting of polyethylene glycols, polytetramethylene glycols, and mixtures thereof; and a carbonate group linking the poly(arylene ether) block and the poly(alkylene ether) block.

Another embodiment is an article comprising any of the above-described poly(arylene ether)-poly(alkylene ether) block copolymers. Such articles may be prepared by the article forming methods described in the context of the poly(arylene ether)-polycarbonate block copolymers. Specific articles for which the poly(arylene ether)-poly(alkylene ether) block copolymers may be used include, for example, sheets and films for coating and packaging.

Poly(Arylene Ether)-Polysiloxane Block Copolymers

One embodiment is a method of preparing a poly(arylene ether)-polysiloxane block copolymer, comprising: reacting a poly(arylene ether), a hydroxyaryl-terminated polysiloxane, and an activated aromatic carbonate. The reaction can occur in a polymer melt (that is, in the absence of intentionally added solvent), or in solution (that is, in the presence of an intentionally added solvent). Suitable solvents for solution reactions include aromatic hydrocarbon solvents (for example, benzene, toluene, ethylbenzene, xylenes), halogenated aromatic hydrocarbon solvents, (for example, chlorobenzene, dichlorobenzenes, and trichlorobenzenes), and halogenated aliphatic hydrocarbon solvents (for example, methylene chloride, chloroform, carbon tetrachloride, dichloroethanes, dichloroethylenes, trichloroethanes, and trichloroethylene).

The term “melt reacting” refers to a reaction conducted in the absence of added solvent. (It will be understood that melt reactions encompass reactions that generate products that may act as solvents. For example, a melt reaction of bis(methyl salicyl) carbonate may generate methyl salicylate.) Melt reaction conditions generally include a temperature that is above the melting and/or glass transition temperatures of the poly(arylene ether) and hydroxyaryl-terminated polysiloxane reactants, but below a temperature at which those reactants are substantially unstable. The melt reaction may be conducted by blending the poly(arylene ether), the polysiloxane, and the activated aromatic carbonate before heating to a temperature suitable for melt reaction. Alternatively, the activated aromatic carbonate may be melt reacted with either the poly(arylene ether) or the polysiloxane before the other polymer is added. In some embodiments, melt reaction conditions include one or more of the following process conditions: one or more temperatures in the range of about 90 to about 400° C., removal of volatile components using a vacuum of about 1 to 100 kilopascals, and agitation (for example stirring at about 1 to 100 rpm). Representative melt reaction conditions are described in detail in the working examples, below.

The poly(arylene ether) and the activated aromatic carbonate are the same as those described above in the context of the poly(arylene ether)-polycarbonate block copolymer.

The hydroxyaryl-terminated polysiloxane may comprise repeating units having the structure

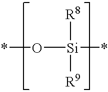

wherein each occurrence of R⁸ and R⁹ is independently hydrogen, C₁-C₁₂ hydrocarbyl, or C₁-C₁₂ halohydrocarbyl; and at least one terminus (end group) having the structure

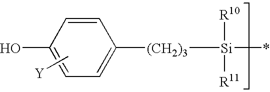

wherein Y is hydrogen, C₁-C₁₂ hydrocarbyl, C₁-C₁₂ hydrocarbyloxy, or halogen, and wherein each occurrence of R¹⁰ and R¹¹ is independently hydrogen, C₁-C₁₂ hydrocarbyl, or C₁-C₁₂ halohydrocarbyl. In one embodiment, each occurrence of R⁸, R⁹, R¹⁰, and R¹¹ is independently methyl or phenyl, and Y is methoxy. In addition to terminal hydroxyaryl groups, the polysiloxane may comprise one or more hydroxyaryl groups within the chain. The polysiloxane may also comprise one or more branching units such as, for example, those resulting from the use of one or more monomers such as CH₃SiCl₃, CH₃Si(OCH₂CH₃)3, SiCl₄, and Si(OCH₂CH₃)₄ during synthesis of the polysiloxane. Thus, the polysiloxane may, optionally, further comprise one or more of the branching units

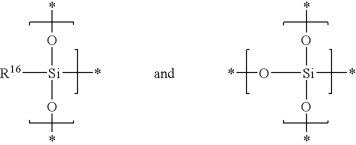

wherein each occurrence of R¹⁶ is independently at each occurrence hydrogen, C₁-C₁₂ hydrocarbyl, or C₁-C₁₂ halohydrocarbyl.

In one embodiment, the hydroxyaryl-terminated polysiloxane has the structure

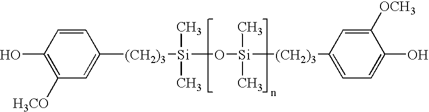

wherein n is 5 to about 200. Within this range, n may be at least 10, or at least 20, or at least 30. Also within this range, n may be up to about 100, or up to about 60, or up to about 40.

In some embodiments, the activated aromatic carbonate may be used in an amount of about 0.5 to about 2 moles per two moles of total hydroxy groups contributed by the poly(arylene ether) and the hydroxyaryl-terminated polysiloxane. Within this range, the activated aromatic carbonate amount may be at least about 0.75 mole, or at least about 0.95 mole, or at least about 1 mole per two moles of hydroxy groups. Also within this range, the activated aromatic carbonate amount may be up to about 1.5 moles, or up to about 1.3 moles, or up to about 1.2 moles, or up to 1.1 moles, or up to 1.05 moles, per two moles of hydroxy groups.

There is no particular limit on the weight ratio of poly(arylene ether) and hydroxyaryl-terminated polysiloxane used in the reaction mixture or incorporated into the resulting copolymer. In one embodiment, the weight ratio of the poly(arylene ether) to the hydroxyaryl-terminated polysiloxane is about 1:10 to about 10:1. Within this range, the weight ratio may be at least about 1:3, or at least about 1:1. Also within this range, the weight ratio may be up to about 6:1, or up to about 3:1.

The structure of the poly(arylene ether)-polysiloxane block copolymer may take a variety of forms. For example, the poly(arylene ether)-polysiloxane block copolymer may be a diblock copolymer, a triblock copolymer, a linear multiblock copolymer having more than three blocks, or a radial teleblock copolymer. In one embodiment, the poly(arylene ether)-polysiloxane block copolymer is a poly(arylene ether)-polysiloxane-poly(arylene ether) triblock copolymer. The block architecture of the copolymer may be controlled via the number of hydroxy groups on the poly(arylene ether), the number of hydroxy groups on the polysiloxane, the ratio of moles of activated carbonate to total moles of hydroxy groups on the poly(arylene ether) and polysiloxane, the use of an endcapping agent, as well as other reaction conditions. For example, when the poly(arylene ether) is predominantly monofunctional (that is, it has, on average, close to one hydroxy group per molecule) and the polysiloxane has, on average, close to two hydroxy groups per molecule, the reaction products may include a poly(arylene ether)-polysiloxane-poly(arylene ether) triblock copolymer.

One embodiment is a method of preparing a poly(arylene ether)-poly(alkylene ether) block copolymer, comprising melt reacting a poly(arylene ether) comprising a hydroxy group, a hydroxyaryl-terminated polysiloxane, and bis(methyl salicyl) carbonate; wherein the poly(arylene ether) has an intrinsic viscosity of about 0.04 to about 0.2 deciliters per gram at 25° C. in chloroform and comprises 2,6-dimethyl-1,4-phenylene ether units, 2,3,6-trimethyl-1,4-phenylene ether units, or a combination thereof; wherein the hydroxyaryl-terminated polysiloxane has the structure

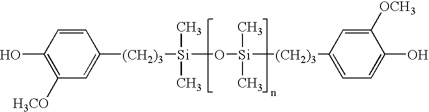

wherein n is about 10 to about 100; wherein the weight ratio of the poly(arylene ether) to the hydroxyaryl-terminated polysiloxane is about 1:3 to about 6:1; and wherein the activated aromatic carbonate is used in an amount of about 0.5 to about 2 moles per two moles of total hydroxy groups contributed by the poly(arylene ether) and the hydroxy-terminated polysiloxane.

Other embodiments include poly(arylene ether)-polysiloxane block copolymers prepared by any of the above-described methods.

One embodiment is a poly(arylene ether)-polysiloxane block copolymer comprising a poly(arylene ether) block, a hydroxyaryl-terminated polysiloxane block, and a carbonate group linking the poly(arylene ether) block and the polysiloxane block. It will be understood that in the context of describing the product block copolymer, “hydroxyaryl-terminated polysiloxane block” refers to a block that does not include the hydroxy group hydrogen atom(s) of the reactant hydroxyaryl-terminated polysiloxane. In other words, in the context of the product block copolymer, the “hydroxyaryl-terminated polysiloxane block” may also be referred to as an “oxyaryl-terminated polysiloxane block”.

One embodiment is a a poly(arylene ether)-polysiloxane block copolymer, consisting of: at least one poly(arylene ether) block; at least one hydroxyaryl-terminated polysiloxane block; and at least one carbonate group linking the poly(arylene ether) block and the polysiloxane block.

One embodiment is a poly(arylene ether)-polysiloxane block copolymer, comprising: a poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; a hydroxyaryl-terminated polysiloxane block having a number average molecular weight of about 1,000 to about 5,000 atomic mass units, wherein the hydroxyaryl-terminated polysiloxane block has the structure

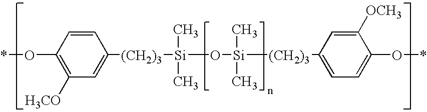

wherein n is about 5 to about 200; and a carbonate group linking the poly(arylene ether) block and the poly(alkylene ether) block.

One embodiment is a poly(arylene ether)-polysiloxane block copolymer, consisting of: at least one poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; at least one hydroxyaryl-terminated polysiloxane block having a number average molecular weight of about 1,000 to about 8,000 atomic mass units, wherein the hydroxyaryl-terminated polysiloxane block has the structure

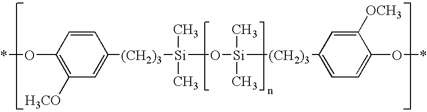

wherein n is about 5 to about 200; at least one carbonate group linking the poly(arylene ether) block and the poly(alkylene ether) block; and optionally, at least one endcap derived from an endcapping agent.

Another embodiment is an article comprising any of the above-described poly(arylene ether)-polysiloxane block copolymers. Such articles may be prepared by the article forming methods described in the context of the poly(arylene ether)-polycarbonate block copolymers. Specific articles for which the poly(arylene ether)-polysiloxane block copolymers may be used include, for example, low-smoke construction materials, coatings for high heat applications.

Poly(Arylene Ether)-Polyester Block Copolymers

One embodiment is a method of preparing a poly(arylene ether)-polyester block copolymer, comprising: reacting a poly(arylene ether) comprising a hydroxy group, a hydroxy-terminated polyester, and an activated aromatic carbonate. The reaction can occur in a polymer melt (that is, in the absence of intentionally added solvent), or in solution (that is, in the presence of an intentionally added solvent). Suitable solvents for solution reactions include aromatic hydrocarbon solvents (for example, benzene, toluene, ethylbenzene, xylenes), halogenated aromatic hydrocarbon solvents, (for example, chlorobenzene, dichlorobenzenes, and trichlorobenzenes), and halogenated aliphatic hydrocarbon solvents (for example, methylene chloride, chloroform, carbon tetrachloride, dichloroethanes, dichloroethylenes, trichloroethanes, and trichloroethylene).

The term “melt reacting” refers to a reaction conducted in the absence of added solvent. (It will be understood that melt reactions encompass reactions that generate products that may act as solvents. For example, a melt reaction of bis(methyl salicyl) carbonate may generate methyl salicylate.) Melt reaction conditions generally include a temperature that is above the melting and/or glass transition temperatures of the poly(arylene ether) and hydroxy-terminated polyester reactants, but below a temperature at which those reactants are substantially unstable. The melt reaction may be conducted by blending the poly(arylene ether), the polyester, and the activated aromatic carbonate before heating to a temperature suitable for melt reaction. Alternatively, the activated aromatic carbonate may be melt reacted with either the poly(arylene ether) or the polyester before the other polymer is added. In some embodiments, melt reaction conditions include one or more of the following process conditions: one or more temperatures in the range of about 90 to about 400° C., removal of volatile components using a vacuum of about 1 to 100 kilopascals, and agitation (for example stirring at about 1 to 100 rpm). Representative melt reaction conditions are described in detail in the working examples, below.

The poly(arylene ether) and the activated aromatic carbonate are the same as those described above in the context of the poly(arylene ether)-polycarbonate block copolymer.

The hydroxy-terminated polyester is a polyester having at least one terminal aliphatic hydroxy group. The hydroxy-terminate polyester may comprise two or three or more than three terminal aliphatic hydroxy groups. In some embodiments, the hydroxy-terminated polyester comprises ester repeating units having the structure

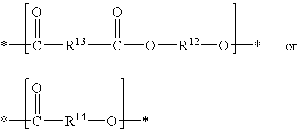

wherein each occurrence of R¹² is independently C₂-C₁₂ alkylene, each occurrence of R¹³ is independently C₂-C₁₂ hydrocarbylene, each occurrence of R¹⁴ is independently C₂-C₆ alkylene; and a terminal hydroxy group

In one embodiment, the hydroxy-terminated polyester is a polyester diol having the structure

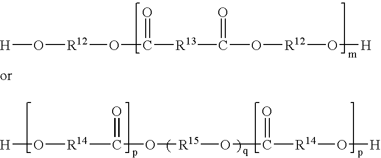

wherein each occurrence of R¹² is independently C₂-C₁₂ alkylene, each occurrence of R¹³ is independently C₂-C₁₂ hydrocarbylene, each occurrence of R¹⁴ is independently C₂-C₆ alkylene, each occurrence of R¹⁵ is independently C₂-C₁₂ alkylene, m is 2 to about 100, each occurrence of p is independently 1 to about 50, and q is 0 to about 10. Methods of making hydroxy-terminated polyesters are known. For example, polyester diols having the first structure above may be prepared by copolymerizing a diacid and a diol, where the diol is present in a molar excess relative to the diacid. As another example, polyester diols having the second structure above may be prepared by using water or a diol (HO—R¹⁵—OH) or an oligomeric polyether (H—(O—R¹⁵)_{q}—OH) to initiate polymerization of a lactone. Hydroxy-terminated polyesters having more than two hydroxy groups may be prepared by polymerizing a monomer mixture that includes a polyfunctional compound having at least three hydroxy groups, at least three carboxylic acids groups, or at least three total hydroxy and carboxylic acid groups.

Suitable hydroxy-terminated polyesters include, for example, polyethylene terephthalate diols, polybutylene terephthalate diols, polycyclohexylene terephthalate diols, polyethylene adipate diols, polybutylene adipate diols, polycyclohexylene adipate diols, polycaprolactone diols, and mixtures thereof. In one embodiment, the hydroxy-terminated polyester is a polycaprolactone diol. Suitable hydroxy-terminated polyesters further include the corresponding polyols obtained by including a branching agent in the polyester backbone.

The hydroxy-terminated polyester may have a number average molecular weight of about 500 to about 10,000 atomic mass units. Within this range, the number average molecular weight may be at least about 1,000 atomic mass units. Also within this range, the number average molecular weight may be up to about 8,000, or up to about 5,000 atomic mass units.

In some embodiments, the activated aromatic carbonate may be used in an amount of about 0.5 to about 2 moles per two moles of total hydroxy groups contributed by the poly(arylene ether) and the hydroxy-terminated polyester. Within this range, the activated aromatic carbonate amount may be at least about 0.75 mole, or at least about 0.95 mole, or at least about 1 mole per two moles of hydroxy groups. Also within this range, the activated aromatic carbonate amount may be up to about 1.5 moles, or up to about 1.3 moles, or up to about 1.2 moles, or up to 1.1 moles, or up to 1.05 moles, per two moles of hydroxy groups.

There is no particular limit on the weight ratio of poly(arylene ether) and hydroxy-terminated polyester used in the reaction mixture or incorporated into the resulting copolymer. In one embodiment, the weight ratio of the poly(arylene ether) to the hydroxy-terminated polyester is about 1:10 to about 10:1. Within this range, the weight ratio may be at least about 1:1, or at least about 2:1. Also within this range, the weight ratio may be up to about 5:1.

The structure of the poly(arylene ether)-polyester block copolymer may take a variety of forms. For example, the poly(arylene ether)-polyester block copolymer may be a diblock copolymer, a triblock copolymer, a linear multiblock copolymer having more than three blocks, or a radial teleblock copolymer. In one embodiment, the poly(arylene ether)-polyester block copolymer is a poly(arylene ether)-polyester-poly(arylene ether) triblock copolymer. The block architecture of the copolymer may be controlled via the number of hydroxy groups on the poly(arylene ether), the number of hydroxy groups on the hydroxy-terminated polyester, the ratio of moles of activated carbonate to total moles of hydroxy groups on the poly(arylene ether) and the hydroxy-terminated polyester, the use of an endcapping agent, as well as other reaction conditions. For example, when the poly(arylene ether) is predominantly monofunctional (that is, it has, on average, close to one hydroxy group per molecule) and the polyester has, on average, close to two hydroxy groups per molecule, the reaction products may include a poly(arylene ether)-polyester-poly(arylene ether) triblock copolymer.

One embodiment is a method of preparing a poly(arylene ether)-polyester block copolymer, comprising melt reacting a poly(arylene ether) comprising a hydroxy group, a polyester diol, and bis(methyl salicyl) carbonate; wherein the poly(arylene ether) has an intrinsic viscosity of about 0.04 to about 0.2 deciliters per gram at 25° C. in chloroform and comprises 2,6-dimethyl-1,4-phenylene ether units, 2,3,6-trimethyl-1,4-phenylene ether units, or a combination thereof; wherein the polyester diol is a polycaprolactone diol having a number average molecular weight of about 500 to about 10,000 atomic mass units; wherein the weight ratio of the poly(arylene ether) to the polyester diol is about 1:3 to about 6:1; and wherein the activated aromatic carbonate is used in an amount of about 0.5 to about 2 moles per two moles of total hydroxy groups contributed by the poly(arylene ether) and the polyester diol.

Other embodiments include poly(arylene ether)-polyester block copolymers prepared by any of the above-described methods.

One embodiment is a poly(arylene ether)-polyester block copolymer comprising a poly(arylene ether) block, a hydroxy-terminated polyester block, and a carbonate group linking the poly(arylene ether) block and the hydroxy-terminated polyester block. It will be understood that within the context of the product block copolymer, the “hydroxy-terminated polyester block” will not include hydroxy group hydrogens at positions bonded to a carbonate group that links different blocks of the copolymer.

One embodiment is a poly(arylene ether)-polyester block copolymer, consisting of: at least one poly(arylene ether) block; at least one hydroxy-terminated polyester block; and at least one carbonate group linking the poly(arylene ether) block and the hydroxy-terminated polyester block.

One embodiment is a poly(arylene ether)-polyester block copolymer, comprising: a poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; a polycaprolactone diol block having a number average molecular weight of about 500 to about 10,000 atomic mass units; and a carbonate group linking the poly(arylene ether) block and the poly(alkylene ether) block.

One embodiment is a poly(arylene ether)-polyester block copolymer, consisting of: at least one poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof; at least one polycaprolactone diol block having a number average molecular weight of about 500 to about 10,000 atomic mass units; at least one carbonate group linking the poly(arylene ether) block and the poly(alkylene ether) block; and optionally, at least one endcap derived from an encapping agent.

Another embodiment is an article comprising any of the above-described poly(arylene ether)-polyester block copolymers. Such articles may be prepared by the article forming methods described in the context of the poly(arylene ether)-polycarbonate block copolymers. Specific articles for which the poly(arylene ether)-polysiloxane block copolymers may be used include, for example, sheets and films for coating and packaging.

Additives and Articles

Any of the above-described block copolymers may optionally be compounded with any conventional additives used in thermoplastics applications, such as preparing molded articles. These additives include UV stabilizers, antioxidants, heat stabilizers, mold release agents, coloring agents, antistatic agents, slip agents, antiblocking agents, lubricants, anticlouding agents, coloring agents, natural oils, synthetic oils, waxes, organic fillers, inorganic fillers, and mixtures thereof. Typically, it is preferable to form a blend of the block copolymer and non-filler additives, which aid in processing the blend to form the desired molded article. The blend may optionally comprise about 0.0001 to about 10 percent by weight of the desired non-filler additives, or about 0.0001 to about 1 percent by weight of the desired non-filler additives. Fillers are typically used in an amount of about 1 to about 75 weight percent, based on the total weight of the composition.

Examples of UV absorbers include, for example, salicylic acid UV absorbers, benzophenone UV absorbers, benzotriazole UV absorbers, cyanoacrylate UV absorbers, and mixtures thereof. Examples of heat-resistant stabilizers, include, for example, phenol stabilizers, organic thioether stabilizers, organic phosphite stabilizers, hindered amine stabilizers, epoxy stabilizers, and mixtures thereof. The heat-resistant stabilizer may be added in the form of a solid or liquid. Examples of the mold-release agents include, for example, natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acids, polyhydric alcohol esters of fatty acids, polyglycol esters of fatty acids, and other fatty acid ester mold release agents; silicone oil and other silicone mold release agents, and mixtures of any of the aforementioned. Coloring agents include pigments, dyes, and mixtures thereof. Inorganic coloring agents and organic coloring agents may be used separately or in combination.

Another embodiment is an article comprising any of the above-described block copolymers. For example, an article may comprise a film, sheet, molded object, or composite, wherein the film, sheet, molded object or composite comprises at least one layer comprising the block copolymer. Articles may be prepared from compositions comprising the block copolymers using fabrication methods known in the art, including, for example, single layer and multilayer foam extrusion, single layer and multilayer sheet extrusion, injection molding, blow molding, extrusion, film extrusion, profile extrusion, pultrusion, compression molding, thermoforming, pressure forming, hydroforming, vacuum forming, foam molding, and the like. Combinations of the foregoing article fabrication methods may be used. Specific articles for which the block copolymers may be used include, for example, medical devices, packaging for pharmaceutical and healthcare products, substrates for data storage media, coated wire, ribbon cable, connectors, buffer tubes, and battery cases.

The invention is further illustrated by the following non-limiting examples.

### EXAMPLES 1-17

All the molecular weight values referred to herein are relative to polystyrene standards and measured using gel permeation chromatography (GPC).

General Procedure for the Batch Preparation of PPE-PC Block Copolymers

In the following procedure, varying amounts of poly(2,6-dimethyl-1,4-phenylene ether) (abbreviated as PPE), bisphenol A (BPA), BMSC, and 1,4-hydroquinone (abbreviated as HQ), 2-methyl-1,4-hydroquinone (abbreviated as MeHQ), or mixtures of 1,4-hydroquinone and 2-methyl-1,4-hydroquinone were taken to produce a variety of poly(2,6-dimethyphenylene ether)-polycarbonate block copolymers. The poly(2,6-dimethyl-1,4-phenylene ether) had an average of about 0.5 hydroxy groups per molecule and a number average molecular weight of 1,326 atomic mass units

To facilitate visual observation and achieve satisfactory levels of polymer purity, the melt transesterification polymerization process was carried out in a 500-milliliter glass reactor equipped with a solid nickel helical agitator. To remove any sodium from the glass, the reactor was soaked in 3 normal hydrochloric acid for at least 12 hours followed by soaking in deionized (18 megaohm) water for at least 12 hours. The reactor was then dried in an oven overnight and stored covered until use. The reactor temperature was maintained using a fluidized sand bath equipped with a Proportional-Integral-Derivative (PID) controller. The temperature was measured near the reactor/sand bath interface. The pressure in the reactor was controlled by a nitrogen bleed into the vacuum pump downstream of the distillate collection flasks and measured with an MKS Pirani gauge. The required catalyst amounts—tetramethyl ammonium hydroxide (TMAH) (Sachem, 2.19×10⁻⁵ mole) or tetrabutylphosphonium acetate (TBPA) (Sachem, 2.19×10⁻⁵ mole), and sodium hydroxide (J. T. Baker, 8.76×10⁻⁶ mole) were prepared by diluting stock solutions of 0.22 molar TMAH or TBPA, and 1.00×10⁻³ molar sodium hydroxide, respectively, with the appropriate amount of 18 megaohm deionized water. When increased levels of a catalyst were needed the concentration of the catalyst solution was increased so that the volume of material injected into the reactor remained constant.

The reactor was charged with the appropriate amounts of solid bisphenol-A, the powder form of the poly(2,6-dimethylphenylene ether), 1,4-hydroquinone, 2-methyl-1,4-hydroquinone, or mixtures of 1,4-hydroquinone and 2-methyl-1,4-hydroquinone; and solid bis(methyl salicyl) carbonate (1.0-1.05 moles per total moles dihydroxy aromatic compound employed); and para-cumyl phenol chain stopper (Aldrich, 1-3 mole percent). The catalyst solution was then added. The reactor was assembled, sealed and the atmosphere was exchanged with nitrogen three times. With the final nitrogen exchange the reactor was brought to near atmospheric pressure and submerged into the fluidized bath, maintained at a temperature of 180-200° C. The contents of the reactor were agitated for five minutes at 250 rpm. After an additional ten minutes, when all of the reactants were presumed to have fully melted, the temperature was raised to 210° C. over a period of five minutes. Next the pressure was reduced to 180 mm Hg. Distillation of by-product began immediately. After 20 minutes, the pressure was again reduced to 100 mm Hg and maintained for 20 minutes. The temperature was then raised to 240° C. over five minutes, and the pressure was lowered to 15 mm Hg. After being maintained at this condition for 20 minutes, the temperature was raised to 270° C. over five minutes and the pressure was lowered to 2 mm Hg. These conditions were maintained for 10 minutes. The temperature was then raised to 310° C. (the final finishing temperature) over 10 minutes, and the pressure was reduced to 1.1 mm Hg. After 30 minutes the reactor was removed from the sand bath and the resulting molten block copolymer product was pulled from the reactor and dropped into liquid nitrogen to quench the reaction.

The procedure described above was repeated with various mixtures of the feed mixture components. Results are shown as Examples 1-17 in Table 1.

In Table 1, the amount of PPE is expressed as weight percent values relative to the overall weight of the feed mixture. The amounts of BPA, HQ, and MeHQ are expressed in terms of relative mole percent values relative to the total moles of bisphenol. Differential scanning calorimetry (DSC) was used to determine glass transition temperatures, melting temperatures, and crystallization temperatures. Samples were analyzed on a Perkin Elmer DSC 7 Differential Scanning Calorimeter using a circular nitrogen environment. Heating and cooling cycles were carried out at 20° C./minute from 30° C. to 380° C. then held for 3 minutes and cooled to 30° C. at the same rate. Two heating cycles were performed for each sample. T_{g} and Tₘ denote the glass transition temperature and the melting temperature (that is, the temperature indicating the onset of melting) of the product PPE-PC block copolymer. T_{c} indicates the crystallization temperature. The notation “NA” in means “not apparent” or “not observed”.

### EXAMPLE 18

The feed mixture components (PPE, MeHQ, HQ, BPA, and catalyst) were combined in a melt reactor and equilibrated at 180° C. for approximately 2 hours to provide a solution comprising the products of the equilibration reaction in methyl salicyate. The solution was then fed at 180° C. into a 14-barrel, 25 millimeter Werner&Pfleiderer twin-screw extruder equipped with six vacuum vents. The feed rate was 6.8-9.1 kilograms per hour (15-20 pounds per hour). The extruder barrel set temperatures were maintained at 280° C., and the screw speed set to 300 rpm. The desired block copolymer was extruded as a clear strand that crystallized and turned opaque as it passed through the cooling water bath en route to the pelletizer. The product melt crystalline PPE-PC block copolymer had a melting temperature of 281° C. and a crystallization temperature of 231° C. No glass transition temperature was observed for this sample.

TABLE 1
Preparation of Melt Crystalline Poly(2,6-dimethylphenylene ether)-
Polycarbonate Block Copolymers.

| | PPE | MeHQ | HQ | | | | |
|---|---|---|---|---|---|---|---|
| | (weight | (mole | (mole | BPA (mole | | | |
| | percent) | percent) | percent) | percent) | T_{g}(° C.) | Tₘ(° C.) | T_{c} (° C.) |
| Ex. 1 | 50 | 90 | 0 | 10 | 110, 215 | (a) | NA |
| Ex. 2 | 50 | 92 | 0 | 8 | 110, 215 | (a) | NA |
| Ex. 3 | 50 | 100 | 0 | 0 | NA | >320 | NA |
| Ex. 4 | 50 | 94 | 0 | 6 | 116 | 270 | NA |
| Ex. 5 | 30 | 10 | 60 | 30 | 124, 194 | 320 | NA |
| Ex. 6 | 50 | 0 | 40 | 60 | 128, 200 | NA | NA |
| Ex. 7 | 50 | 0 | 50 | 50 | 130, 205 | NA | NA |
| Ex. 8 | 50 | 0 | 60 | 40 | 124 | 316 | NA |
| Ex. 9 | 30 | 0 | 50 | 50 | 135, 208 | NA | NA |
| Ex. 10 | 30 | 94 | 0 | 6 | 121 | 269 | NA |
| Ex. 11 | 30 | 95 | 0 | 5 | 103 | 273 | NA |
| Ex. 12 | 30 | 96 | 0 | 4 | 100 | 276 | NA |
| Ex. 13 | 30 | 97 | 0 | 3 | 108 | 279 | 158 |
| Ex. 14 | 30 | 87 | 10 | 3 | NA | 272 | 203 |
| Ex. 15 | 30 | 82 | 15 | 3 | NA | 277 | 219 |
| Ex. 16 | 30 (b) | 82 | 15 | 3 | NA | 291 | 208 |
| Ex. 17 | 30 (c) | 82 | 15 | 3 | NA | 287 | 196 |
| Ex. 18 | 30 | 82 | 15 | 3 | NA | 281 | 231 |

(a) Amorphous polymer.
(b) PPE used had intrinsic viscosity of 0.12 deciliter per gram in chloroform at 25° C.
(c) PPE used had intrinsic viscosity of 0.31 deciliter per gram in chloroform at 25° C.

The results show that melt crystalline block copolymers prepared from poly(2,6-dimethylphenylene)ethers having at least one hydroxy group, various combinations of hydroquinone and/or 2-methyl-1,4-hydroquinone, and BPA can provide materials which have glass transition temperatures of about 100 to about 135° C., and, in some cases, melting points of about 260 to about 330° C., thus enabling them to be easily processed for producing a variety of molded articles. Further, since the poly(arylene ether)s can be readily and inexpensively prepared, the block copolymers are economically attractive. The results from Examples 8 and 12 show that incremental amounts of 1,4-hydroquinone added at the expense of 2-methyl-1,4-hydroquinone can increase the melting temperature (Tₘ) by about 12° C.

### EXAMPLES 19-21, COMPARATIVE EXAMPLES 6 AND 7

These examples illustrate the preparation of block copolymers of poly(arylene ether)s and poly(alkylene ether)s.

A “monofunctional” poly(2,6-dimethyl-1,4-phenylene ether) having a hydroxy group (OH) content of 5,924 parts per million by weight, a weight average molecular weight of about 6,300 atomic mass units, and a number average molecular weight of about 3,700 atomic mass units was obtained as PPO* SA120 from GE Plastics (“PPE, 0.12 IV” in Table 1). A “bifunctional” poly(2,6-dimethyl-1,4-phenylene ether) having a hydroxy group (OH) content of 17,470 parts per million by weight and a weight average molecular weight of about 2,477 atomic mass units was prepared by oxidative copolymerization of 2,6-xylenol and tetramethyl bisphenol A. A polyethylene glycol having a weight average molecular weight of about 8,548 atomic mass units and a hydroxy group content of 2,914 parts per million by weight was obtained as CARBOWAX® 8000 from Dow Chemical.

The following general process was used for the preparation of block copolymers. The melt polymerization process was carried out in a glass reactor equipped with a twisted anchor type stirrer. To remove any sodium from the glass, the reactor was soaked in 1 N hydrochloric acid for at least 24 hours followed by excessive rinsing in Milli-Q water. The reactor was then dried with acetone, flushed with air and stored covered until use. The reactor temperature was controlled using a heating mantle equipped with an Omega-Newport controller. The temperature was measured near the reactor/heating mantle interface. An Omega controller with nitrogen bleed was used to control the pressure in the reactor. The required catalyst was prepared by diluting stock solutions of 0.5 M sodium hydroxide with the appropriate amount of Milli-Q water. When increased levels of a catalyst were needed the concentration of the catalyst solution was increased so that the volume of material injected into the reactor remained constant.

The reactor was charged with the amounts of polymers and BMSC detailed in Table 4, where poly(arylene ether) and polyethylene glycol component amounts are expressed in parts by weight. The BMSC amount is expressed as the number of moles of BMSC for every two moles of hydroxy groups contributed by the poly(arylene ether) and polyethylene glycol. The reactors were sealed and vacuum was pulled to about 2 millibars then returned to atmospheric pressure with a nitrogen purge. This purging step was repeated two more times. The reactor was heated to 90° C. for 30 minutes under full vacuum to remove any residual moisture from the catalyst. The pressure was returned to atmospheric using a nitrogen purge and the reactor was heated to various levels, depending on the program used (for detail on program see program summary table 1). Independent of the reaction program used, there is a melting period during which all reagents are uniformly blended. Once a uniform molten blend is generated, a second phase, the oligomerization under moderate vacuum, is performed allowing for low level coupling to take place, finally at high temperature and under high vacuum block copolymer formation is driven by the removal of the volatile methyl salicylate.

Two different time profiles of temperature, vacuum, and stirring were used. Examples 19 and 20 and Comparative Example 6 used the time profile detailed in Table 2. Example 21 and Comparative Example 7 used the time profile detailed in Table 3. In Tables 2 and 3, time is expressed in minutes (min), temperature is expressed in degrees centigrade (° C.), vacuum is expressed in millibars (mbar), and stirring is expressed in rpm.

The product consisted of the entire contents of the reactor, which were analyzed without further purification or isolation.

TABLE 2

| Time (min) | Temperature (° C.) | Vacuum (mbar) | Stirring (rpm) |
|---|---|---|---|
| 0 | 90 | 0 | 0 |
| 30 | 160 | 1000 | 40 |
| 45 | 160 | 500 | 40 |
| 60 | 260 | 500 | 40 |
| 65 | 260 | 100 | 40 |
| 75 | 260 | 0 | 40 |
| 85 | 260 | 1000 | 40 |

TABLE 3

| Time (min) | Temperature (° C.) | Vacuum (mbar) | Stirring (rpm) |
|---|---|---|---|
| 0 | 90 | 0 | 0 |
| 30 | 160 | 1000 | 0 |
| 40 | 160 | 1000 | 40 |
| 45 | 160 | 500 | 40 |
| 60 | 260 | 500 | 40 |
| 65 | 260 | 100 | 40 |
| 75 | 260 | 0 | 40 |
| 85 | 260 | 1000 | 0 |

¹³C NMR was used to determine the relative amounts of various molecular fragments. Specifically, a pulse sequence allowing quantitative integration of ¹³C NMR resonances was used to determine the relative molar amounts of (1) carbonate carbon atoms linking a poly(arylene ether) fragment and a polycarbonate fragment (“% PPE-PEG carbonate” in Table 4), (2) carbonate carbon atoms linking two poly(arylene ether) fragments (“% PPE-PPE carbonate” in Table 4), (3) carbonate carbon atoms linking two polyethylene glycol fragments (“% PEG-PEG carbonate” in Table 4), (4) all carbon atoms associated with poly(arylene ether) fragments (“% PPE” in Table 4), and (5) all carbon atoms associated with polyethylene glycol fragments (“% PEG” in Table 4). The number average molecular weight (Mₙ) and weight average molecular weight (M_{w}) were determined by gel permeation chromatography (GPC) using monodisperse polystyrene standards, a styrene divinyl benzene gel at 40° C., and samples having a concentration of 1 milligram per milliliter of chloroform. The polydispersity index, M_{w}/Mₙ, is the ratio of the weight average molecular weight to the number average molecular weight. Property values are presented in Table 4.

TABLE 4

| | | | | |
|---|---|---|---|---|
| Ex. 19 | Ex. 20 | Ex. 21 | C. Ex. 6 | C. Ex. 7 |

Reactants

| | | | | | |
|---|---|---|---|---|---|
| PPE, 0.12 IV | 9.9977 | 9.9831 | 0 | 0 | 30.1348 |
| PPE, 0.09 IV | 0 | 0 | 8.6178 | 0 | 0 |
| Carbowax 8000 | 15.8361 | 15.8565 | 21.4243 | 20.0229 | 0 |
| Mole Ratio BMSC:2OH | 1.140 | 1.205 | 1.07 | 0.7705 | 1.008 |

Properties

| | | | | | |
|---|---|---|---|---|---|
| % PPE-PEG | 0.30 | 0.31 | 0.46 | 0 | 0 |
| carbonate | | | | | |
| % PPE-PPE | 0.09 | 0.09 | 0.42 | 0 | 0.56 |
| carbonate | | | | | |
| % PEG-PEG | 0.35 | 0.3 | 0.22 | 0.3 | 0 |
| carbonate | | | | | |
| % PPE | 37.7 | 37.9 | 20.3 | 0 | 99.4 |
| % PEG | 61.2 | 61.3 | 79.10 | 99.1 | NA |
| M_{w} | 18200 | 27500 | 118900 | NA | 16100 |
| Mₙ | 6300 | 6530 | 9590 | NA | 7270 |
| M_{w}/Mₙ | 2.9 | 4.2 | 12.4 | NA | 2.2 |

The results for Examples 19 and 20 show the reproducibility of this process for preparing the block copolymer. Specifically, for Example 19, 0.30% of the total carbon resonances were attributable to carbonate linkages in PPE-PEG block copolymer, and for Example 20, 0.31% of the total carbon resonances were attributable to carbonate linkages in PPE-PEG block copolymers. The results for Example 21 illustrate that the block copolymer process can utilize a multifunctional poly(arylene ether) (that is, a poly(arylene ether) comprising, on average, more than one hydroxy group per molecule). The results for Examples 19-21 illustrate that a significant percentage of the carbonate linkages are attributable to coupling of a PPE unit and a PEG unit. Specifically, for Example 19, 41% (100*0.30/(0.30+0.09+0.35)) of the total carbonate carbon resonances were attributable to carbonate linkages in PPE-PEG block copolymer, for Example 20, 44% of the carbonate carbon resonances were attributable to carbonate linkages in PPE-PEG block copolymers, and for Example 21, 42% of the carbonate carbon resonances were attributable to carbonate linkages in PPE-PEG block copolymers. In all cases, the molecular weight of the resulting copolymer is greater than the molecular weight of the respective polymers used in its synthesis. Comparative Examples 6 and 7 are controls in which formation of mixed block copolymers was not possible because either poly(arylene ether) (C. Ex. 6) or polyethylene glycol (C. Ex. 7) was omitted.

### EXAMPLES 22-28

These examples illustrate the preparation of block copolymers of poly(arylene ether)s and polyesters.

Some of the starting materials are the same as those used above. In addition, poly(2,6-dimethyl-1,4-phenylene ether) having a hydroxy group (OH) content of 3,240 parts per million by weight, a weight average molecular weight of about 27,700 atomic mass units, and a number average molecular weight of about 10,000 atomic mass units was prepared by blending 75 weight percent of a PPE resin having an intrinsic viscosity of 0.31 deciliter per gram obtained as PPO* 808 and 25 weight percent of a PPE resin having an intrinsic viscosity of 0.12 deciliter per gram obtained as PPO* SA120, both from GE Plastics (this resin blend is designated “PPE, 0.25 IV” in Table 8). Polycaprolactone diols (PCL) having weight average molecular weights of about 1,000, 2,000, 4,000, and 8,000 atomic mass units, and hydroxy group contents of about 33,939, 16,970, 8,489, and 4,242 parts per million by weight were obtained from Solvay Chemical as CAPA® 2100, 2200, 2403, and 2803, respectively.

The general reaction procedures of Examples 19-21 were used, except that polycaprolactone diols were substituted for polyethylene glycols. Three different time profiles of temperature, vacuum, and stirring were used in these experiments. For Examples 22, 23, and 27, the conditions detailed in Table 5 were used; for Examples 24-26, the conditions detailed in Table 6 were used; for Example 28, the conditions detailed in Table 7 were used.

TABLE 5

| Time (min) | Temperature (° C.) | Vacuum (mbar) | Stirring (rpm) |
|---|---|---|---|
| 0 | 90 | 0 | 0 |
| 30 | 200 | 1000 | 0 |
| 45 | 200 | 1000 | 40 |
| 65 | 250 | 1000 | 40 |
| 75 | 250 | 0 | 40 |
| 85 | 250 | 1000 | 0 |

TABLE 6

| Time (min) | Temperature (° C.) | Vacuum (mbar) | Stirring (rpm) |
|---|---|---|---|
| 0 | 90 | 0 | 0 |
| 30 | 200 | 1000 | 0 |
| 35 | 250 | 1000 | 40 |
| 55 | 250 | 0 | 40 |
| 65 | 250 | 1000 | 0 |

TABLE 7

| Time (min) | Temperature (° C.) | Vacuum (mbar) | Stirring (rpm) |
|---|---|---|---|
| 0 | 90 | 0 | 0 |
| 30 | 200 | 1000 | 0 |
| 35 | 250 | 1000 | 25 |
| 45 | 270 | 500 | 25 |
| 55 | 270 | 500 | 40 |
| 62 | 280 | 100 | 40 |
| 75 | 280 | 0 | 40 |
| 80 | 280 | 1000 | 0 |

Product molecular weights were determined as described for Examples 19-21. Product hydroxy content was determined by Fourier Transform Infrared Spectroscopy (FTIR), using 2,6-dimethylphenol standards to construct intensity versus concentration curves. Product glass transition temperatures were determined by differential scanning calorimetry (DSC). Reaction compositions and product properties are summarized in Table 8.

TABLE 8

| | | | | |
|---|---|---|---|---|
| Ex. 22 | Ex. 23 | Ex. 24 | Ex. 25 | Ex. 26 |

Reactants

| | | | | | |
|---|---|---|---|---|---|
| PPE, 0.12 IV | 25.9077 | 22.8035 | 25.8232 | 25.8081 | 18.3947 |
| PPE, 0.25 IV | 0 | 0 | 0 | 0 | 0 |
| PCL, 1,000 M_{w} | 4.1218 | 0 | 0 | 0 | 0 |
| PCL, 2,000 M_{w} | 0 | 7.2503 | 8.2023 | 8.1941 | 0 |
| PCL, 4,000 M_{w} | 0 | 0 | 0 | 0 | 11.6911 |
| PCL, 8,000 M_{w} | 0 | 0 | 0 | 0 | 0 |
| BMSC:2OH | 1.21 | 1.23 | 1.50 | 2.00 | 1.21 |

Properties

| | | | | | |
|---|---|---|---|---|---|
| % PPE-PCL | 1.09 | 0.53 | 0.51 | 0.52 | 0.16 |
| carbonate | | | | | |
| % PPE-PPE | 0.26 | 0.31 | 0.23 | 0.23 | 0.35 |
| carbonate | | | | | |
| % PCL-PCL | 0.16 | 0.44 | 0.15 | 0.19 | 0 |
| carbonate | | | | | |
| % PPE | 80.45 | 69.65 | 68.20 | 67.47 | 81.94 |
| % PCL | 15.45 | 26.96 | 29.77 | 26.54 | 16.61 |
| Post reaction OH | NA | 177 | NA | NA | 1403 |
| (ppm) | | | | | |
| Mw(AMU) | 16300 | 15000 | 18200 | 14700 | 10400 |
| Mn (AMU) | 9180 | 8330 | 10000 | 8050 | 5660 |
| M_{w}/Mₙ | 1.8 | 1.8 | 1.8 | 1.8 | 1.8 |
| Tg (deg C.) | 131 | 146 | 146 | 149 | 169 |

| | |
|---|---|
| Ex. 27 | Ex. 28 |

Reactants

| | | |
|---|---|---|
| PPE, 0.12 IV | 13.2170 | 0 |
| PPE, 0.25 IV | 0 | 23.2991 |
| PCL, 1,000 M_{w} | 0 | 0 |
| PCL, 2,000 M_{w} | 0 | 0 |
| PCL, 4,000 M_{w} | 0 | 0 |
| PCL, 8,000 M_{w} | 16.7584 | 6.7432 |
| BMSC:2OH | 1.20 | 1.51 |

Properties

| | | |
|---|---|---|
| % PPE-PCL | 0 | 0.16 |
| carbonate | | |
| % PPE-PPE | 0.29 | 0.21 |
| carbonate | | |
| % PCL-PCL | 0 | 0 |
| carbonate | | |
| % PPE | 60.03 | 71.2 |
| % PCL | 36.77 | 28.1 |
| Post reaction OH | 450 | 394 |
| (ppm) | | |
| Mw(AMU) | 12700 | 121800 |
| Mn (AMU) | 7080 | 22900 |
| M_{w}/Mₙ | 1.8 | 5.3 |
| Tg (deg C.) | 180 | 200 |

The results for Examples 22, 23, 26, and 27 show that use of lower molecular weight PCL diol is associated with a larger absolute yield of PPE-PCL block copolymer. Specifically, as the PCL diol weight average molecular weight is increased from 1,000 to 2,000, to 4,000, to 8,000, the percent of total carbon atoms associated carbonate moieties linking PPE and PCL chains decreases from 1.09% to 0.53% to 0.16% to 0%. These same examples also illustrate that the relative yield of desired block copolymer decreases with increasing PCL diol molecular weight. Specifically, as the PCL diol weight average molecular weight is increased from 1,000 to 2,000, to 4,000, to 8,000, the percent of total carbonate carbon atoms associated carbonate moieties linking PPE and PCL chains decreases from 72% (100*1.09/(1.09+0.26+0.16)) to 41% to 31% to 0%. However, it was unexpectedly found that PPE-PCL block copolymers containing high molecular weight PCL fragments could be formed when the poly(arylene ether) was a blend of poly(arylene ether) resins having intrinsic viscosities of 0.30 and 0.12 deciliters per gram. See Example 28. Examples 23-25 show that the absolute yield of desired PPE-PCL block copolymer is robust to substantial variations in the molar amount of activated carbonate relative to total moles of hydroxy groups.

### EXAMPLES 29-33

These examples illustrate the preparation of block copolymers of poly(arylene ether)s and polysiloxanes.

The following eugenol-capped polydimethylsiloxanes were prepared by a platinum-catalyzed hydrosilylation reaction between eugenol and hydride-diterminated polydimethylsiloxanes: D10 fluid having a weight average molecular weight of about 1,202 atomic mass units and a hydroxy group content of 25,740 parts per million by weight; D15 fluid having a weight average molecular weight of about 1,752 atomic mass units and a hydroxy group content of about 19,750 parts per million by weight; and D24 fluid having a weight average molecular weight of about 2,238 atomic mass units and a hydroxy group content of about 15,360 parts per million.

All of these examples used the time profile of temperature, vacuum, and stirring detailed in Table 6, above. Reaction compositions and properties are summarized in Table 9. Although it was theoretically possible to observe more than one glass transition temperature, only one was observed. Example 29 shows the importance of activated carbonate concentrate for the coupling reaction. In this example, the molar ratio of activated carbonate to total hydroxy groups was 0.54, and only a small yield of the desired block copolymer was obtained. The deficiency of activated carbonate is also reflected in the large amount of unreacted hydroxy groups and the low weight average molecular weight of the Example 29 product.

TABLE 9

| | Ex. 29 | Ex. 30 | Ex. 31 | Ex. 32 | Ex. 33 |
|---|---|---|---|---|---|
| Reactants | | | | | |
| PPE, 0.12 IV | 15.0068 | 24 | 24.9912 | 25.1031 | 25.0935 |
| Siloxane, 1,202 M_{w} | 15.1734 | 0 | 0 | 0 | 0 |
| Siloxane, 1,752 M_{w} | 0 | 6.2105 | 0 | 0 | 0 |
| Siloxane, 2,238 M_{w} | 0 | 0 | 8.8435 | 8.9062 | 8.9513 |
| BMSC:2OH | 0.54 | 0.98 | 0.91 | 1.49 | 1.99 |
| Properties | | | | | |
| % PPE-PCL | 0.19 | 0.69 | 0.68 | 0.93 | 0.46 |
| carbonate | | | | | |
| % PPE-PPE | 0 | 0.35 | 0.27 | 0.33 | 0.16 |
| carbonate | | | | | |
| % PCL-PCL | 0.24 | 0.12 | 0.15 | 0.28 | 0.38 |
| carbonate | | | | | |
| % PPE | 85.70 | 76.09 | 75.2 | 70.53 | 68.84 |
| % Siloxane | 12.3 | 22.15 | 23.7 | 27.55 | 26.44 |
| Post reaction OH | 4442 | 1242 | 1833 | NA | NA |
| (ppm) | | | | | |
| M_{w} (AMU) | 9095 | 13200 | 12300 | 19300 | 12600 |
| Mₙ (AMU) | 5050 | 7300 | 6710 | 10800 | 6920 |
| M_{w}/Mₙ | 1.8 | 1.8 | 1.8 | 1.8 | 1.8 |
| Tg (° C.) | 148 | 156 | 166 | 165 | 155 |

### EXAMPLES 34-39

These examples further illustrate the preparation of block copolymers of poly(arylene ether)s and poly(alkylene ether)s.

A poly(2,6-dimethyl-1,4-phenylene ether) having an intrinsic viscosity of 0.12 deciliter per gram, a number average molecular weight of 2,340 atomic mass units, a weight average molecular weight of 4,322 atomic mass units, and a hydroxy group content of 9,618 parts per million by weight was prepared by oxidative copolymerization of 2,6-xylenol and tetramethyl bisphenol A. Polytetramethylene glycols having number average molecular weights of about 650, 1,400, and 2,900 were obtained as TERATHANE® PTMEG 650, 1400, and 2900, respectively, from Invista. p-Cumyl phenol was obtained from Schenectady Chemicals.

To facilitate observations and for purity, melt transesterification reactions were carried out in a 500-milliliter glass batch reactor equipped with a solid nickel helical agitator. To remove any sodium from the glass the reactor was soaked in 3 N hydrochloric acid for at least 12 hours followed by a soak in 18 megaohm water for at least 12 hours. The reactor was then dried in an oven overnight and stored covered until use. The temperature of the reactor was maintained using a fluidized sand bath with a PID controller and measured near the reactor and sand bath interface. The pressure over the reactor was controlled by a nitrogen bleed into the vacuum pump downstream of the distillate collection flasks and measured with an MKS Pirani gauge. Tetramethyl ammonium hydroxide (Sachem, 2.19×10⁻⁵ mol) or tetrabutylphosphonium acetate (Sachem, 2.19×10⁻⁵ mol) and sodium hydroxide (J. T. Baker, 8.76×10⁻⁶ mol) were prepared by dilution to the proper concentrations (0.220 M tetramethyl ammonium hydroxide and tetrabutylphosphonium acetate, and 1.00×10⁻³ M sodium hydroxide) with 18 megaohm water. When increased levels or a catalyst were needed the concentration of the catalyst solution was increased to maintain consistent injection volumes.

The procedure for Examples 34-36 was typical. The reactor was charged with poly(arylene ether) in powder form (40.0 grams, 0.009 moles), polytetramethyleneglycol (60.0 grams 0.0923 moles), and bis(methyl salicyl) carbonate (35.1 grams, 0.106 moles). In these experiments the monofunctional phenol was p-cumyl phenol added at about 0.02 moles/mole BMSC. The catalyst was added to the solid charge but could also have been added after the reactant polymer mixture was melted. The reactor was then assembled and sealed, and the atmosphere was exchanged with nitrogen three times. With the final nitrogen exchange the reactor was brought to near atmospheric pressure and submerged into the fluidized bath, which was at 180-200° C. After five minutes agitation was begun at 250 rpm. After an additional ten minutes the reactants were fully melted and a homogeneous mixture was obtained. At this point timing began and the temperature was ramped to 210° C. over five minutes. Once at temperature, the pressure was reduced to 180 millimeters of mercury and methyl salicylate distillate was immediately formed. After 20 minutes the pressure was again reduced to 100 millimeters of mercury and maintained for 20 minutes. The temperature was then ramped to 240° C. over five minutes and the pressure was lowered to 15 millimeters of mercury. These conditions were maintained for up to 20 minutes. The temperature was then ramped to 260° C. over five minutes and the pressure was lowered to 2.0 millimeters of mercury. These conditions were maintained for 10 minutes. The temperature was then ramped to the final finishing temperature of 260-290° C. over ten minutes and the pressure was reduced to 1.1 millimeters of mercury. After 30 minutes the reactor was removed from the sand bath and the melt was pulled from the reactor and dropped into liquid nitrogen to quench the reaction.

Properties of block copolymers prepared using this procedure are summarized in Table 10. Product intrinsic viscosity was measured at 25° C. in chloroform on block copolymer samples that had been dried for 1 hour at 125° C. under vacuum. The viscometry sample concentration was 0.40 grams per 50 milliliters chloroform. Shore A hardness was measured at 25° C. according to ASTM D 2240 using a Rex Model DD-3-A digital durometer with OS-2H operating stand.

TABLE 10

| | Ex. 34 | Ex. 35 | Ex. 36 | Ex. 37 | Ex. 38 |
|---|---|---|---|---|---|
| Reactants | | | | | |
| PPE, 0.12 IV | 60 | 50 | 40 | 30 | 40 |
| PTMEG 650 | 0 | 0 | 0 | 0 | 0 |
| PTMEG | 0 | 0 | 0 | 0 | 60 |
| 1400 | | | | | |
| PTMEG | 40 | 50 | 60 | 70 | 60 |
| 2900 | | | | | |
| BMSC:2OH | 1.0 | 1.0 | 1.0 | 1.0 | 1.0 |
| Properties | | | | | |
| IV (dL/g) | 0.48 | 0.41 | 0.50 | 0.50 | 0.46 |
| Mₙ (AMU) | 51426 | 49795 | 56236 | 40464 | 28022 |
| M_{w} (AMU) | 16053 | 15967 | 18670 | 14912 | 12239 |
| M_{w}/Mₙ | 3.2 | 3.1 | 3.0 | 2.7 | 2.3 |
| Shore A | 78.0 | 89.0 | 57.0 | 33.0 | 56.0 |
| Hardness | | | | | |
| Tg 1 | −60 | −50 | −50 | −50 | −50 |
| (deg C.) | | | | | |
| Tg 2 | 145 | 112 | * | * | * |
| (deg C.) | | | | | |

| | Ex. 39 | Ex. 40 | Ex. 41 |
|---|---|---|---|
| Reactants | | | |
| PPE, 0.12 IV | 40 | 40 | 40 |
| PTMEG 650 | 60 | 60 | 60 |
| PTMEG 1400 | 0 | 0 | 0 |
| PTMEG 2900 | 0 | 0 | 0 |
| BMSC:2OH | 1.0 | 1.0 | 1.0 |
| Properties | | | |
| IV (dL/g) | 0.47 | 0.47 | 0.47 |
| Mₙ (AMU) | 17607 | 18580 | 17638 |
| M_{w} (AMU) | 8767 | 8368 | 8635 |
| M_{w}/Mₙ | 2.0 | 2.2 | 2.0 |
| Shore A Hardness | 42.0 | 47.0 | 42.0 |
| Tg 1 (deg C.) | −50 | −45 | −50 |
| Tg 2 (deg C.) | * | * | * |

*weak, difficult to determine

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

1. A method of preparing a poly(arylene ether)-polysiloxane block copolymer, comprising reacting a poly(arylene ether) comprising a hydroxy group, a hydroxyaryl-terminated polysiloxane, and an activated aromatic carbonate.

2. The method of claim 1, wherein said reacting comprises melt reacting.

3. The method of claim 1, wherein said reacting comprises reacting in a solvent.

4. The method of claim 1, wherein the poly(arylene ether) comprises repeating structural units having the formula 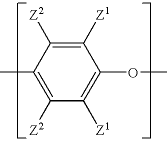
wherein for each structural unit, each Z¹ is independently halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl with the proviso that that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atom.

5. The method of claim 1, wherein the poly(arylene ether) comprises 2,6-dimethyl-1,4-phenylene ether units, 2,3,6-trimethyl-1,4-phenylene ether units, or a combination thereof.

6. The method of claim 1, wherein the poly(arylene ether) has an intrinsic viscosity of about 0.04 to about 0.6 deciliter per gram at 25° C. in chloroform.

7. The method of claim 1, wherein the poly(arylene ether) has, on average, about 0.5 to 1 aromatic hydroxy group per chain.

8. The method of claim 1, wherein the poly(arylene ether) has, on average, greater than 1 aromatic hydroxy group per chain.

9. The method of claim 1, wherein the hydroxyaryl-terminated polysiloxane comprises
repeating units having the structure 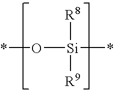
wherein each occurrence of R⁸ and R⁹ is independently hydrogen, C₁-C₁₂ hydrocarbyl or C₁-C₁₂ halohydrocarbyl; and
a terminus having the structure 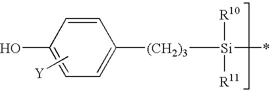
wherein Y is hydrogen, C₁-C₁₂ hydrocarbyl, C₁-C₁₂ hydrocarbyloxy, or halogen, and wherein each occurrence of R¹⁰ and R¹¹ is independently hydrogen, C₁-C₁₂ hydrocarbyl or C₁-C₁₂ halohydrocarbyl.

10. The method of claim 9, wherein each occurrence of R⁸, R⁹, R¹⁰, and R¹¹ is independently methyl or phenyl, and wherein Y is methoxy.

11. The method of claim 1, wherein the hydroxyaryl-terminated polysiloxane has the structure 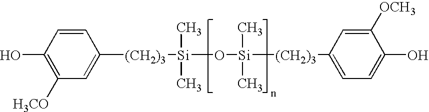
wherein n is 5 to about 200.

12. The method of claim 1, wherein the activated aromatic carbonate is selected from the group consisting of bis(o-chlorophenyl) carbonate, bis(o-nitrophenyl) carbonate, bis(o-acetylphenyl) carbonate, bis(o-phenylketonephenyl) carbonate, bis(o-formylphenyl) carbonate, bis(methyl salicyl) carbonate, and mixtures thereof.

13. The method of claim 1, wherein the activated aromatic carbonate is bis(methyl salicyl) carbonate.

14. The method of claim 1, wherein the activated aromatic carbonate is used in an amount of about 0.5 to about 2 moles per two moles of total hydroxy groups contributed by the poly(arylene ether) and the polysiloxane.

15. The method of claim 1, wherein the weight ratio of the poly(arylene ether) to the hydroxyaryl-terminated polysiloxane is about 1:10 to about 10:1.

16. The method of claim 1, further comprising melt reacting an endcapping agent with the poly(arylene ether), the hydroxyaryl-terminated polysiloxane, and the activated aromatic carbonate.

17. The method of claim 1, wherein the poly(arylene ether)-polysiloxane block copolymer is a diblock copolymer, a triblock copolymer, a linear multiblock copolymer having more than three blocks, or a radial teleblock copolymer.

18. The method of claim 1, wherein the poly(arylene ether)-polysiloxane block copolymer is a poly(arylene ether)-polysiloxane-poly(arylene ether) triblock copolymer.

19. A poly(arylene ether)-polysiloxane block copolymer prepared by the method of claim 1.

20. A method of preparing a poly(arylene ether)-poly(alkylene ether) block copolymer, comprising melt reacting a poly(arylene ether) comprising a hydroxy group, a hydroxyaryl-terminated polysiloxane, and bis(methyl salicyl) carbonate;
wherein the poly(arylene ether) has an intrinsic viscosity of about 0.04 to about 0.2 deciliters per gram at 25° C. in chloroform and comprises 2,6-dimethyl-1,4-phenylene ether units, 2,3,6-trimethyl-1,4-phenylene ether units, or a combination thereof;
wherein the hydroxyaryl-terminated polysiloxane has the structure 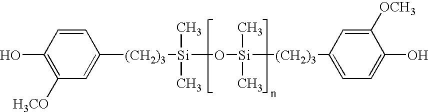
wherein n is about 10 to about 100;
wherein the weight ratio of the poly(arylene ether) to the hydroxyaryl-terminated polysiloxane is about 1:3 to about 6:1; and
wherein the activated aromatic carbonate is used in an amount of about 0.5 to about 2 moles per two moles of total hydroxy groups contributed by the poly(arylene ether) and the hydroxy-terminated polysiloxane.

21. A poly(arylene ether)-polysiloxane block copolymer prepared by the method of claim 20.

22. A poly(arylene ether)-polysiloxane block copolymer, comprising:
a poly(arylene ether) block;
a hydroxyaryl-terminated polysiloxane block; and
a carbonate group linking the poly(arylene ether) block and the polysiloxane block.

23. A poly(arylene ether)-polysiloxane block copolymer, consisting of:
at least one poly(arylene ether) block;
at least one hydroxyaryl-terminated polysiloxane block; and
at least one carbonate group linking the poly(arylene ether) block and the polysiloxane block.

24. A poly(arylene ether)-polysiloxane block copolymer, comprising:
a poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof;
a hydroxyaryl-terminated polysiloxane block having a number average molecular weight of about 1,000 to about 5,000 atomic mass units, wherein the hydroxyaryl-terminated polysiloxane block has the structure 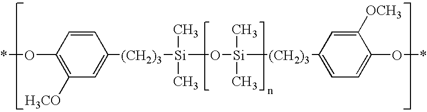
wherein n is about 5 to about 200; and
a carbonate group linking the poly(arylene ether) block and the poly(alkylene ether) block.

25. A poly(arylene ether)-polysiloxane block copolymer, consisting of:
at least one poly(arylene ether) block having an intrinsic viscosity of about 0.04 to about 0.2 deciliters per gram at 25° C. in chloroform and comprising 2,6-dimethyl-1,4-phenylene ether units, 2,3,6-trimethyl-1,4-phenylene ether units, or a combination thereof;
at least one hydroxyaryl-terminated polysiloxane block having a number average molecular weight of about 1,000 to about 8,000 atomic mass units, wherein the hydroxyaryl-terminated polysiloxane block has the structure 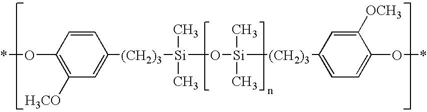
wherein n is about 5 to about 200;
at least one carbonate group linking the poly(arylene ether) block and the poly(alkylene ether) block; and
optionally, at least one endcap derived from an endcapping agent.

26. An article comprising the poly(arylene ether)-polysiloxane block copolymer of claim 19.

27. An article comprising the poly(arylene ether)-polysiloxane block copolymer of claim 21.

28. An article comprising the poly(arylene ether)-polysiloxane block copolymer of claim 22.

29. An article comprising the poly(arylene ether)-polysiloxane block copolymer of claim 23.

30. An article comprising the poly(arylene ether)-polysiloxane block copolymer of claim 24.

31. An article comprising the poly(arylene ether)-polysiloxane block copolymer of claim 25.
